(19) United States
(12) Patent Application Publication
(10) Pub. No.: US 2026/0095096 A1
(43) Pub. Date: Apr. 2, 2026

(54) VOLTAGE CONVERTER AND OPERATION METHOD THEREOF

(71) Applicant: Samsung Electronics Co., Ltd., Suwon-si (KR)

(72) Inventors: Donghee CHO, Suwon-si (KR); Hyeungjoon CHA, Suwon-si (KR); Dae-Hoon HAN, Suwon-si (KR); Heeseok HAN, Suwon-si (KR)

(73) Assignee: Samsung Electronics Co., Ltd., Suwon-si (KR)

(21) Appl. No.: 19/330,267

(22) Filed: Sep. 16, 2025

(30) Foreign Application Priority Data
Sep. 27, 2024 (KR) 10-2024-0132073
Jan. 10, 2025 (KR) 10-2025-0004179

(51) Int. Cl. H02M 3/156

(52) U.S. Cl. CPC H02M 3/156

(57) ABSTRACT

A voltage converter includes a first circuit including a first switch, a second switch, an inductor and a current source, the first circuit being configured to convert an input voltage into an output voltage based on a switching operation of the first switch and the second switch, and processing circuitry configured to generate a first reference voltage and a second reference voltage, control the switching operation of the first switch and the second switch based on an inductor current flowing in the inductor, the output voltage and the first reference voltage, reduce the first reference voltage and the second reference voltage to a reset voltage during a soft-stop time period of a soft-stop phase, and control a discharge current flowing in the current source in the soft-stop phase based on a magnitude of the inductor current, the output voltage and the second reference voltage.

### CROSS-REFERENCE TO RELATED APPLICATIONS

This application claims priority under 35 U.S.C. § 119 to Korean Patent Application No. 10-2024-0132073 filed on Sep. 27, 2024 and Korean Patent Application No. 10-2025-0004179 filed on Jan. 10, 2025, in the Korean Intellectual Property Office, the disclosures of each of which are incorporated by reference herein in their entireties.

### BACKGROUND

Embodiments of the present disclosure relate to a voltage converter and, more particularly, relate to a voltage converter that performs a soft-stop operation with improved performance and a soft-stop operation method of the voltage converter.

An electronic device may receive one input voltage from a voltage source. The electronic device may operate using various internal voltages, and levels of the internal voltages may differ from a level of the input voltage. To generate the various internal voltages, the electronic device may include a voltage converter that converts an input voltage to an internal voltage.

The voltage converter may include a buck converter and a boost converter. The buck converter may convert the input voltage to an output voltage that is lower than the input voltage. The boost converter may convert the input voltage to the output voltage that is higher than the input voltage. For example, a buck-boost converter may selectively perform a buck conversion and a boost conversion when the level of the input voltage varies.

When the voltage converter terminates operation, it may perform the soft-stop operation to discharge the output voltage. When the voltage converter performs the soft-stop operation, an undershoot or an overshoot in the input voltage or the output voltage may occur. When the voltage converter performs the soft-stop operation, the more the undershoot or the overshoot in the input voltage or the output voltage is suppressed, the more the operation characteristics of the voltage converter may be improved.

### SUMMARY

Embodiments of the present disclosure provide a voltage converter that performs a soft-stop operation and a soft-stop operation method of the voltage converter with improved performance.

According to embodiments, a voltage converter includes a first circuit including a first switch, a second switch, an inductor and a current source, the first circuit being configured to convert an input voltage into an output voltage based on a switching operation of the first switch and the second switch, and processing circuitry configured to generate a first reference voltage and a second reference voltage, control the switching operation of the first switch and the second switch based on an inductor current flowing in the inductor, the output voltage and the first reference voltage, reduce the first reference voltage and the second reference voltage to a reset voltage during a soft-stop time period of a soft-stop phase, and control a discharge current flowing in the current source in the soft-stop phase based on a magnitude of the inductor current, the output voltage and the second reference voltage.

According to embodiments, a soft-stop operation method of a voltage converter includes reducing, by processing circuitry, a first reference voltage and a second reference voltage to a reset voltage during a soft-stop time period, an offset voltage being added to the first reference voltage to obtain the second reference voltage, detecting, by the processing circuitry, a magnitude of an inductor current flowing in an inductor included in a first circuit, an output voltage of the first circuit being equal to or greater than the first reference voltage, stopping, by the processing circuitry, a switching operation in response to the magnitude of the inductor current being zero, the stopping being performed by controlling a first switch and a second switch included in the first circuit, causing, by the processing circuitry, a discharge voltage to be provided to a current source in response to the magnitude of the inductor current being zero, the current source being included in the first circuit, generating, by the current source, a discharge current in response to the discharge voltage, and discharging, by the current source, the output voltage to the reset voltage based on the discharge current.

According to embodiments, a voltage converter includes a first circuit including a current source for discharging an output voltage, and processing circuitry configured to cause a discharge voltage to be generated based on an inductor current flowing in an inductor, the inductor being included in the first circuit, and perform a soft-stop operation including causing the discharge voltage to be provided to the current source based on a magnitude of the inductor current being zero, the current source being configured to generate a discharge current in response to the discharge voltage, and the discharge current causing the output voltage to discharge to a reset voltage.

According to embodiments, a voltage converter comprises, a converting unit including a first switch, a second switch, and a current source, and configured to convert an input voltage into an output voltage based on a switching operation of the first switch and the second switch, a reference generating unit configured to generate a first reference voltage and a second reference voltage, an active discharging unit configured to generate a discharge voltage based on an inductor current flowing in an inductor included in the converting unit, the output voltage, and the second reference voltage, and a control unit configured to control the switching operation of the first switch and the second switch based on the inductor current, the output voltage, and the first reference voltage. When the voltage converter operates in a soft-stop phase, the converting unit is configured to stop the switching operation in response to a magnitude of the inductor current being zero, the active discharging unit is configured to provide the discharge voltage to the current source, the current source is configured to generate a discharge current in response to the discharge voltage, and the current source is configured to discharge the output voltage to a reset voltage based on the discharge current. The converting unit is configured to perform the switching operation in response to the output voltage and the first reference voltage being equal.

According to embodiments, a soft-stop operation method of a voltage converter, comprises, reducing, by a reference generating unit, a first reference voltage and a second reference voltage to a reset voltage during a soft-stop time period, detecting, by an active discharging unit, a magnitude of an inductor current flowing in an inductor included in a converting unit, stopping, by a first switch and a second switch included in the converting unit, a switching operation, in response to the magnitude of the inductor current being zero, providing, by the active discharging unit, a discharge voltage to a current source included in the converting unit, in response to the magnitude of the inductor current being zero, generating, by the current source, a discharge current, in response to the discharge voltage, discharging, by the current source, an output voltage to the reset voltage based on the discharge current, and performing, by the first switch and the second switch, the switching operation in response to the converting unit detecting that the output voltage and the first reference voltage are equal. The second reference voltage is a voltage that adds an offset voltage to the first reference voltage, and the output voltage is equal to or greater than the first reference voltage.

According to embodiments, an electronic device includes at least one processor and a voltage converter, the voltage converter including a first circuit including a first switch, a second switch, an inductor and a current source, the first circuit being configured to convert an input voltage into an output voltage based on a switching operation of the first switch and the second switch, and processing circuitry configured to generate a first reference voltage and a second reference voltage, control the switching operation of the first switch and the second switch based on an inductor current flowing in the inductor, the output voltage and the first reference voltage, reduce the first reference voltage and the second reference voltage to a reset voltage during a soft-stop time period of a soft-stop phase, and control a discharge current flowing in the current source in the soft-stop phase based on a magnitude of the inductor current, the output voltage and the second reference voltage.

According to embodiments, an electronic device includes at least one processor and a voltage converter, the voltage converter including a first circuit including a current source for discharging an output voltage, and processing circuitry configured to cause a discharge voltage to be generated based on an inductor current flowing in an inductor, the inductor being included in the first circuit, and perform a soft-stop operation including causing the discharge voltage to be provided to the current source based on a magnitude of the inductor current being zero, the current source being configured to generate a discharge current in response to the discharge voltage, and the discharge current causing the output voltage to discharge to a reset voltage.

### BRIEF DESCRIPTION OF DRAWINGS

The above and other objects and features of the present disclosure will become apparent by describing in detail embodiments thereof with reference to the accompanying drawings.

FIG. 1 illustrates a voltage converter according to embodiments of the present disclosure.

FIG. 2 illustrates an operation method of a voltage converter according to embodiments of the present disclosure.

FIGS. 3A and 3B illustrate examples of a first condition and a second condition of a voltage converter according to embodiments of the present disclosure.

FIGS. 4A and 4B illustrate a converting unit according to embodiments of the present disclosure.

FIG. 5 illustrates an operation method of a converting unit according to embodiments of the present disclosure.

FIG. 6 illustrates a reference generating unit according to embodiments of the present disclosure.

FIG. 7 illustrates an operation method of a reference generating unit according to embodiments of the present disclosure.

FIG. 8 illustrates an active discharging unit according to embodiments of the present disclosure.

FIG. 9 illustrates an operation method of an active discharging unit according to embodiments of the present disclosure.

FIG. 10 illustrates a control unit according to embodiments of the present disclosure.

FIG. 11 illustrates an operation method of a control unit according to embodiments of the present disclosure.

FIG. 12 illustrates a more detailed example of an active discharge circuit and a current source according to embodiments of the present disclosure.

FIG. 13 illustrates an operation method of an active discharge circuit and a current source according to embodiments of the present disclosure.

FIGS. 14A and 14B illustrate examples of a first condition and a second condition of a voltage converter according to embodiments of the present disclosure.

FIG. 15 illustrates a detailed operation method of a voltage converter according to embodiments of the present disclosure.

FIG. 16 illustrates an example of a third condition of a voltage converter according to embodiments of the present disclosure.

FIG. 17 is a block diagram illustrating an electronic system to which a voltage converter according to embodiments of the present disclosure is applied.

FIG. 18 is a block diagram illustrating an electronic system to which a voltage converter according to embodiments of the present disclosure is applied.

FIG. 19 is a block diagram illustrating an electronic device to which a voltage converter is applied, according to embodiments of the present disclosure.

FIG. 20 is a diagram illustrating a system to which a voltage converter according to embodiments of the present disclosure is applied.

### DETAILED DESCRIPTION

Below, embodiments of the present disclosure will be described in detail and clearly to such an extent that an ordinary one in the art easily carries out the present disclosure.

Components described with reference to terms such as a unit, a module, a block, a function block (e.g., ˜or, ˜er), circuit, circuitry, and the like used throughout the description and functional blocks illustrated in the drawings may be implemented using software, hardware, or a combination thereof. In embodiments, the software may be or include machine code, firmware, embedded code, source code, application software, and/or combinations thereof. In embodiments, the hardware may be or include an electrical circuit, an electronic circuit (analog circuit or digital circuit), a processor, a computer, an integrated circuit, integrated circuit cores, a pressure sensor, an inertial sensor, a microelectromechanical system (MEMS), a passive device, and/or combinations thereof.

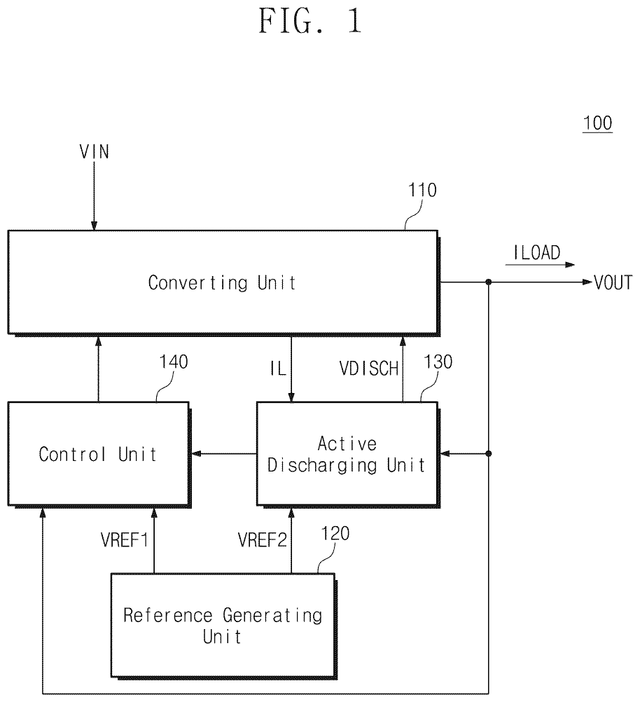

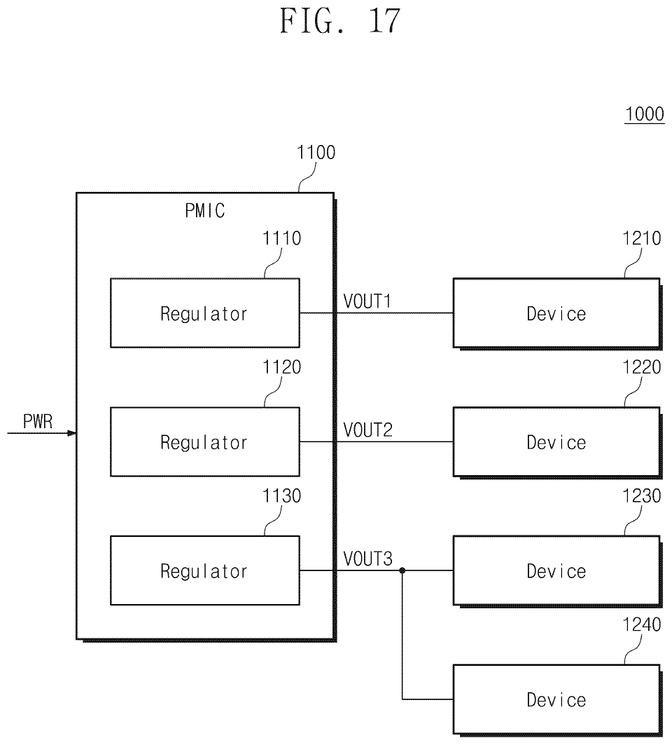

FIG. 1 illustrates a voltage converter according to embodiments of the present disclosure. Referring to FIG. 1, the voltage converter 100 may include a converting unit 110, a reference generating unit 120, an active discharging unit 130, and/or a control unit 140. According to embodiments, the voltage converter 100 may be configured to convert an input voltage to an output voltage, and supply the output voltage to a powered device (e.g., one of the plurality of devices 1210-1240, one of the plurality of apparatuses 2110 to 2140, the electronic device 3000 and/or the system 4000 discussed below in connection with FIGS. 17, 18, 19 and 20). The powered device may use the supplied output voltage to perform powered operations. For example, the powered device may generate a time-varying voltage signal (e.g., a radio frequency signal) and transmit the time-varying voltage signal via an antenna. In another example, the powered device may use photodetectors to convert light incident on a lens into an image and display the image on a screen. In another example, the powered device may transform a time-varying voltage signal (e.g., an audio signal) into a soundwave using a speaker by causing a coil of the speaker to physically move back and forth according to the time-varying voltage signal, causing vibrations in a diaphragm of the speaker representing a sound wave corresponding to the audio signal.

The converting unit 110 may receive an input voltage VIN. Under the control of the control unit 140, the converting unit 110 may convert the input voltage VIN into an output voltage VOUT. For example, the converting unit 110 may include an inductor, a capacitor, a current source, and/or a plurality of switching elements. Under the control of the control unit 140, the plurality of switching elements of the converting unit 110 may perform a switching operation to convert the input voltage VIN into the output voltage VOUT.

For example, a level of the input voltage VIN may be fixed. A target level of the output voltage VOUT may be lower than the level of the input voltage VIN. Thus, the converting unit 110 may perform a buck transform.

The reference generating unit 120 may generate a first reference voltage VREF1 and a second reference voltage VREF2. The reference generating unit 120 may transmit the first reference voltage VREF1 to the control unit 140, and may transmit the second reference voltage VREF2 to the active discharging unit 130. The second reference voltage VREF2 may be greater than the first reference voltage VREF1. Specifically, the second reference voltage VREF2 may be a voltage that adds an offset voltage to the first reference voltage VREF1.

The active discharging unit 130 may receive the output voltage VOUT from the converting unit 110. The active discharging unit 130 may detect a magnitude of an inductor current IL flowing in the inductor included in the converting unit 110. The active discharging unit 130 may receive the second reference voltage VREF2 from the reference generating unit 120.

The active discharging unit 130 may generate the discharge voltage VDISCH based on the magnitude of the inductor current IL, the output voltage VOUT, and the second reference voltage VREF2. For example, the active discharging unit 130 may generate the discharge voltage VDISCH based on whether the magnitude of the inductor current IL is zero and a difference between the output voltage VOUT and the second reference voltage VREF2. The active discharging unit 130 may provide the discharge voltage VDISCH to the converting unit 110. The active discharging unit 130 may control a current source of the converting unit 110 based on the discharge voltage VDISCH. The current source may generate a discharge current in response to the discharge voltage VDISCH.

The control unit 140 may receive the output voltage VOUT from the converting unit 110. The control unit 140 may receive the first reference voltage VREF1 from the reference generating unit 120. The control unit 140 may receive the magnitude of the inductor current IL detected by the active discharging unit 130. For example, the control unit 140 may receive a signal related to whether the magnitude of the inductor current IL is zero from the active discharging unit 130. The control unit 140 may control switching operations of the plurality of switching elements of the converting unit 110 based on the magnitude of the inductor current IL, the output voltage VOUT, and the first reference voltage VREF1. For example, the control unit 140 may control switching operations of the plurality of switching elements of the converting unit 110 based on whether the magnitude of the inductor current IL is zero and whether the output voltage VOUT and the first reference voltage VREF1 are equal to each other.

In the voltage converter 100 according to embodiments of the present disclosure, the output voltage VOUT may be equal to or greater than the first reference voltage VREF1. For example, the control unit 140 may control the switching operation of the plurality of switching elements of the converting unit 110 such that the output voltage VOUT is equal to or greater than the first reference voltage VREF1.

Specifically, the control unit 140 may control, in response to the output voltage VOUT being equal to the first reference voltage VREF1, the plurality of switching elements of the converting unit 110 to perform a switching operation (for example, a buck switching operation) once. If the plurality of switching elements perform the switching operation once, the output voltage VOUT may increase during an on time period from the first reference voltage VREF1 and then decrease again. When the output voltage VOUT increased from the first reference voltage VREF1 during the on time period decreases again to be equal to the first reference voltage VREF1, the plurality of switching elements of the converting unit 110 may perform the switching operation (for example, the buck switching operation) once again. Accordingly, the output voltage VOUT may be equal to or greater than the first reference voltage VREF1 under the control of the control unit 140.

When the voltage converter 100 terminates operation, the voltage converter 100 may perform a soft-stop operation. For example, when the voltage converter 100 terminates operation, the voltage converter 100 may operate in a soft-stop phase for a soft-stop time period. In the soft-stop phase, the voltage converter 100 may perform the soft-stop operation during the soft-stop time period. According to embodiments, the voltage converter 100 may be configured to terminate (or stop, skip, cancel, block, etc.) the supply of the output voltage to the powered device by completing (e.g., following completion of) the soft-stop operation.

Before entering the soft-stop phase, in a switching operation process of the plurality of switching elements, the output voltage VOUT increased during the on time period from the first reference voltage VREF1 may be less than the second reference voltage VREF2. That is, the value at which the output voltage VOUT increases during the on time period may be less than the offset voltage.

In the soft-stop phase, the reference generation unit 120 may reduce the first reference voltage VREF1 and the second reference voltage VREF2 to a reset voltage (e.g., a ground voltage). Further, in the soft-stop phase, the voltage converter 100 may discharge the output voltage VOUT to a reset voltage. Specifically, in the soft-stop phase, the reference generation unit 120 may reduce the first reference voltage VREF1 and the second reference voltage VREF2 to the reset voltage over a soft-stop time period, and the voltage converter 100 may discharge the output voltage VOUT to the reset voltage across the soft-stop time period. For example, the reset voltage may be a ground voltage. In the following, as an example, the reset voltage is described as being a ground voltage, but the present disclosure is not limited thereto.

In the soft-stop phase, a load current ILOAD may flow to an output node from which the output voltage VOUT is output in the voltage converter 100. The load current ILOAD may discharge the output voltage VOUT to a reset voltage. The soft-stop phase may be classified into a first condition or a second condition according to the magnitude of the load current ILOAD.

The first condition may correspond to the condition in which the magnitude (may also be referred to herein as the amplitude) of the load current ILOAD for discharging the output voltage VOUT is sufficient, and the second condition may correspond to the condition in which the amplitude of the load current ILOAD for discharging the output potential VOUT is insufficient or zero. For example, the first condition may correspond to the condition that the output voltage VOUT is discharged to the reset voltage by the load current ILOAD in the soft-stop phase, and the second condition may correspond to the condition that the output voltage VOUT is not discharged to the reset voltage by the load current ILOAD in the soft-stop phase. That is, the first condition may correspond to a heavy load condition, and the second condition may correspond to a light load condition.

In the voltage converter 100, the magnitude of the load current ILOAD may be an average value of the magnitude of the inductor current IL. Thus, in the first condition where the magnitude of the load current ILOAD is sufficient, the magnitude of the inductor current IL may be greater than zero. Further, in the second condition in which the magnitude of the load current ILOAD is insufficient or zero, there may be a time point in time period when the magnitude of the inductor current IL becomes zero.

In the soft-stop phase of the second condition, since the magnitude of the load current ILOAD for discharging the output voltage VOUT is insufficient or zero, the output voltage VOUT may be discharged by a discharge current. That is, in the soft-stop phase of the first condition, the output voltage VOUT is discharged by the load current ILOAD, and in the soft-stop phase of the second condition, the output potential VOUT may be discharged by the discharge current. In the following, in the soft-stop phase of the second condition, that the output voltage VOUT is discharged by the discharge current is referred to as an Active Discharge.

As described above, in the soft-stop phase of the first condition, the magnitude of the inductor current IL is greater than zero, and thus the active discharging unit 130 may not detect that the magnitude of the inductor current IL equals zero. Therefore, the active discharging unit 130 does not generate the discharge voltage VDISCH, and the control unit 140 may maintain the switching operation of the plurality of switching elements of the converting unit 110.

For example, in the soft-stop phase of the first condition, the plurality of switching elements of the converting unit 110 may perform a switching operation corresponding to the first reference voltage VREF1 that is reduced to the reset voltage by the reference generation unit 120. Specifically, in the soft-stop phase of the first condition, the output voltage VOUT increased during the on time period by the switching operation of the plurality of switching elements may be reduced back to the first reference voltage VREF1 by the load current ILOAD. That is, even when the first reference voltage VREF1 is reduced to the reset voltage by the reference generation unit 120, the output voltage VOUT increased from the first reference voltage VREF1 during the on time period may be discharged to the first reference voltage VREF1 reduced by the load current ILOAD.

Therefore, in the soft-stop phase of the first condition, the control unit 140 maintains the switching operation of the plurality of switching elements of the converting unit 110, and the output voltage VOUT may be discharged to the reset voltage by the load current ILOAD.

As described above, in the soft-stop phase of the second condition, since there is a time point at which the magnitude of the inductor current IL becomes zero, the active discharging unit 130 may detect that the magnitude of the inductor current IL is zero. Accordingly, the active discharging unit 130 generates the discharge voltage VDISCH, and the control unit 140 may stop the switching operation of the plurality of switching elements of the converting unit 110.

For example, in the soft-stop phase of the second condition, the plurality of switching elements of the converting unit 110 may stop the switching operation in response to the magnitude of the inductor current IL being zero, and the active discharging unit 130 may generate the discharge voltage VDISCH. In the soft-stop phase of the second condition, since the output voltage VOUT is not discharged to the reset voltage by the load current ILOAD, the output voltage VOUT may be kept constant or overshoot. Thus, as the second reference voltage VREF2 is reduced to the reset voltage by the reference generation unit 120, the difference between the output voltage VOUT and the second reference voltage VREF2 may be reduced. In this case, the active discharging unit 130 may detect that the magnitude of the inductor current IL is zero, and may generate the discharge voltage VDISCH based on a difference between the output voltage VOUT and the second reference voltage VREF2. The current source of the converting unit 110 may generate a discharge current in response to the discharge voltage VDISCH. The output voltage VOUT may be maintained to be less than the second reference voltage VREF2 by the discharge current. In addition, the output voltage VOUT may be discharged to a reset voltage by a discharge current.

Therefore, in the soft-stop phase of the second condition, the control unit 140 stops the switching operation of the plurality of switching elements of the converting unit 110, the current source generates the discharge current based on the discharge voltage VDISCH generated by the active discharging unit 130, and the output voltage VOUT may be discharged to the reset voltage by the discharge current.

As described above, in the soft-stop phase, the voltage converter 100 may perform a soft-stop operation during the soft-stop time period. For example, in the soft-stop phase, the reference generation unit 120 may reduce the first reference voltage VREF1 and the second reference voltage VREF2 to the reset voltage during the soft-stop time period. Thus, in both the first condition and the second condition, the voltage converter 100 may discharge the output voltage VOUT to the reset voltage during the soft-stop time period. That is, the voltage converter 100 according to embodiments of the present disclosure may accurately control the soft-stop time period regardless of the magnitude of the load current ILOAD.

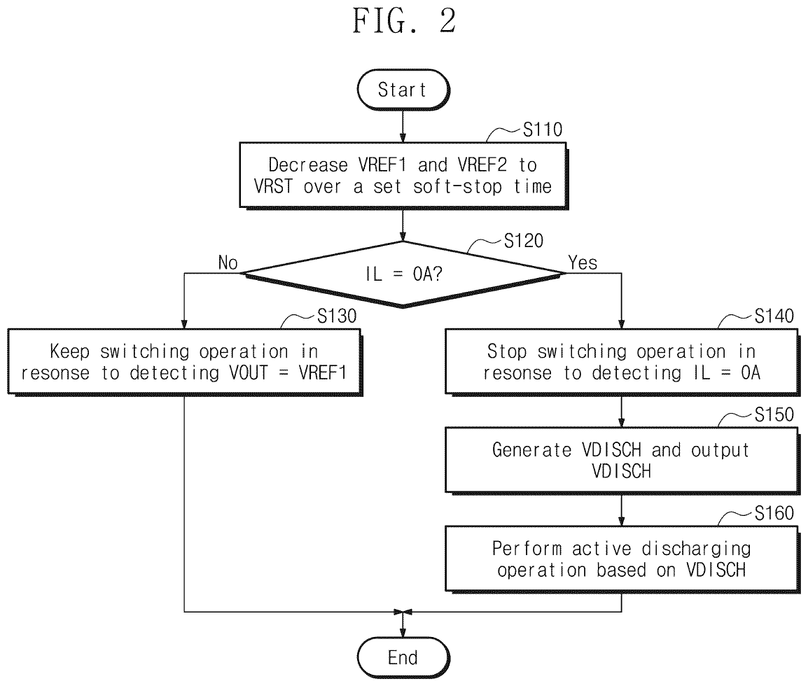

FIG. 2 illustrates an operation method of a voltage converter according to embodiments of the present disclosure. Referring to FIGS. 1 and 2, in operation S110, the voltage converter 100 may reduce, over a set soft-stop time period, the first reference voltage VREF1 and the second reference voltage VREF2 to the reset voltage VRST. For example, the reference generating unit 120 of the voltage converter 100 may reduce, in the soft-stop phase, the first reference voltage VREF1 and the second reference voltage VREF2 to the reset voltage VRST over a soft-stop time period.

In operation S120, the voltage converter 100 may determine whether the magnitude of the inductor current IL is zero. For example, the active discharging unit 130 may detect whether the magnitude of the inductor current IL flowing in the inductor included in the converting unit 110 is zero. If (e.g., in response to determining or detecting) the magnitude of the inductor current IL is not zero, the voltage converter 100 may proceed to operation S130. When (e.g., in response to determining or detecting) the magnitude of the inductor current IL is zero, the voltage converter 100 may proceed to operation S140.

In operation S130, the voltage converter 100 may maintain the switching operation in response to detecting that the output voltage VOUT is equal to the first reference voltage VREF1. For example, the plurality of switching elements of the converting unit 110 of the voltage converter 100 may perform the switching operation once each time the output voltage VOUT and the first reference voltage VREF1 are detected to be equal. For example, the control unit 140 may control the plurality of switching elements of the converting unit 110 of the voltage converter 100 to perform the switching operation once each time the output voltage VOUT and the first reference voltage VREF1 are detected to be equal.

In operation S140, the voltage converter 100 may stop the switching operation in response to sensing that the magnitude of the inductor current IL is zero. For example, the plurality of switching elements of the converting unit 110 of the voltage converter 100 may stop the switching operation in response to the magnitude of the inductor current IL being zero. For example, the control unit 140 may control the plurality of switching elements of the converting unit 110 of the voltage converter 100 to stop the switching operation in response to the magnitude of the inductor current IL being zero.

In operation S150, the voltage converter 100 may generate the discharge voltage VDISCH, and output the discharge voltage VDISCH. For example, the active discharging unit 130 of the voltage converter 100 may generate a discharge voltage VDISCH and provide the generated discharge voltage VDISCH to a current source of the converter.

In operation S160, the voltage converter 100 may perform an active discharge operation based on the discharge voltage VDISCH. For example, the current source of the converting unit 110 of the voltage converter 100 may generate a discharge current based on the discharge voltage VDISCH provided from the active discharging unit 130, and discharge the output voltage VOUT based on the generated discharge current.

For example, operation S130 may correspond to the operation in which the voltage converter 100 performs a soft-stop operation in the soft-stop phase of the first condition, and operations S140 to S160 may correspond to the operations in which the voltage convertor 100 performs a soft-stop operation in the soft-stop phase of the second condition. The output voltage VOUT is discharged to the reset voltage VRST according to any one of operations S130 and S140 to S160, and the voltage converter 100 may terminate the operation.

For example, according to the operation method illustrated in FIG. 2, the time period from the time point when the voltage converter 100 starts the soft-stop operation to the time point when it terminates the soft-stop operation may correspond to a soft-stop time period.

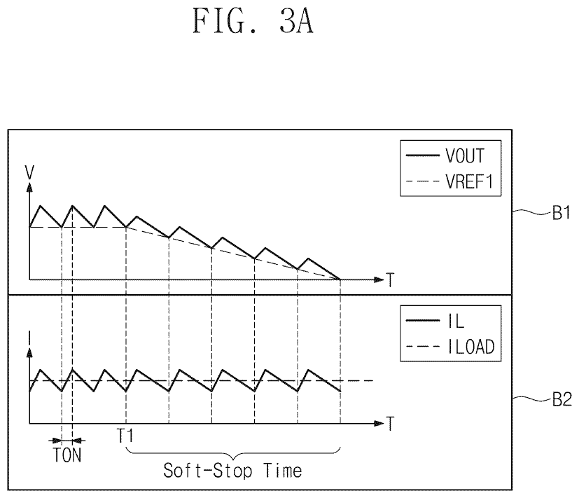

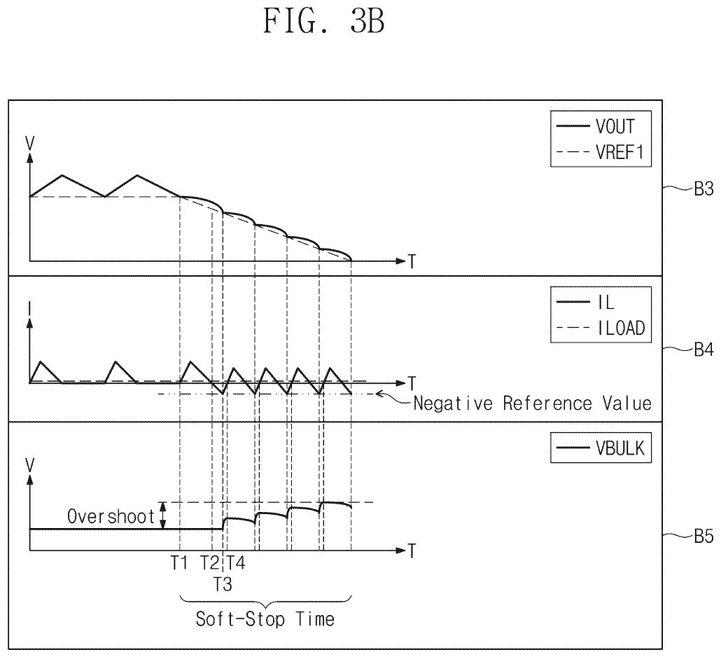

FIGS. 3A and 3B illustrate examples of a first condition and a second condition of a voltage converter according to embodiments of the present disclosure. Referring to FIG. 3A, as an example, an example of the output voltage VOUT, the first reference voltage VREF1, the inductor current IL, and the load current ILOAD according to the flow of time T in the soft-stop phase of the first condition is illustrated. Referring to FIG. 3B, as an example, an example of the output voltage VOUT, the first reference voltage VREF1, the inductor current IL, the load current ILOAD, and the bulk voltage VBULK according to the flow of time T in the soft-stop phase of the second condition is illustrated.

The first box B1 illustrates the change of the output voltage VOUT and the first reference voltage VREF1 in the soft-stop phase of the first condition. The second box B2 illustrates the variation of the inductor current IL and the load current ILOAD in the soft-stop phase of the first condition. The third box B3 illustrates the change of the output voltage VOUT and the first reference voltage VREF1 in the soft-stop phase of the second condition. The fourth box B4 illustrates the variation of the inductor current IL and the load current ILOAD in the soft-stop phase of the second condition. The fifth box B5 illustrates the change of the bulk voltage VBULK in the soft-stop phase of the second condition. In FIGS. 3A and 3B, the horizontal axis of the first box B1, the third box B3, and the fifth box B5 indicates time T, and the vertical axis indicates voltage V. In FIGS. 3A and 3B, the horizontal axis of the second box B2 and the fourth box B4 indicates time T, and the vertical axis indicates current I.

Referring to FIG. 3A, the voltage converter according to embodiments of the present disclosure may perform a switching operation before the first time point T1. For example, the voltage converter may not operate in the soft-stop phase prior to the first time point T1. Before the first time point T1, the voltage converter may perform a switching operation corresponding to the first reference voltage VREF1. For example, before the first time point T1, the plurality of switching elements of the converting unit 110 of the voltage converter may perform a switching operation in response to the output voltage VOUT being equal to the first reference voltage VREF1. Specifically, by the switching operation of the plurality of switching elements, the output voltage VOUT may increase during the on time period TON and then decrease again.

The voltage converter may enter, at a first time point T1, a soft-stop phase of a first condition. For example, the voltage converter may operate in the soft-stop phase for a soft-stop time period after the first time point T1. In the soft-stop phase of the first condition, the voltage converter may reduce the first reference voltage VREF1 to the reset voltage VRST over a soft-stop time period.

In the soft-stop phase of the first condition, the magnitude of the load current ILOAD may be sufficient to discharge the output voltage VOUT. Thus, in the soft-stop phase, it may not be detected that the magnitude of the inductor current IL is zero. In this case, the plurality of switching elements of the converting unit 110 may maintain the switching operation corresponding to the decreasing first reference voltage VREF1.

Referring to FIG. 3B, the voltage converter according to embodiments of the present disclosure may perform a switching operation before the first time point T1. In the voltage converter prior to the first time point T1 in FIG. 3B, except that the time period taken for the output voltage VOUT to increase by the switching operation and then decrease again is relatively long as the magnitude of the load current ILOAD may not be sufficient to discharge the output voltage VOUT, the voltage converter prior to first time point T1 of FIG. 3B may operate the same as (or similar to) the voltage converter prior to first time point T1 of FIG. 3A. Therefore, redundant description is omitted.

In FIG. 3B, the bulk voltage VBULK of the fifth box B5 may be a voltage corresponding to the input voltage VIN. Specifically, the bulk voltage VBULK may be a voltage corresponding to the input voltage VIN with a noise of the input voltage VIN having been removed therefrom.

Referring to FIG. 3B, the voltage converter according to embodiments of the present disclosure may not perform the active discharge operation in the soft-stop phase of the second condition. For example, the voltage converter according to embodiments of the present disclosure may not discharge the output voltage VOUT based on the discharge current generated by the current source in the soft-stop phase of the second condition. For example, the voltage converter according to embodiments of the present disclosure may discharge the output voltage VOUT based on the inductor current IL having a magnitude smaller than zero rather than the discharge current, in the soft-stop phase of the second condition. In this case, the inductor current IL having a magnitude less than zero may cause an overshoot in the bulk voltage VBULK.

The voltage converter may enter a soft-stop phase of the second condition at a first time point T1. For example, the voltage converter may operate in the soft-stop phase for a soft-stop time period after the first time point T1. In the soft-stop phase of the second condition, the voltage converter may not turn off the plurality of switching elements until the magnitude of the inductor current IL reaches a negative reference value less than zero.

For example, at a second time point T2, the magnitude of the inductor current IL may reach zero. However, at the second time point T2, the output voltage VOUT may not discharge to the decreasing first reference voltage VREF1. That is, at the second time point T2, the output voltage VOUT may be greater than the first reference voltage VREF1. Thus, the voltage converter may not perform a switching operation until the magnitude of the inductor current IL reaches a negative reference value less than zero, at a third time point T3. For example, at the third time point T3, the magnitude of the inductor current IL reaches a negative reference value, and the output voltage VOUT may be discharged to the first reference voltage VREF1. Thus, at the third time point T3, the voltage converter may perform a switching operation.

In this case, in a time period between the third time point T3 and a fourth time point T4, the magnitude of the inductor current IL of the voltage converter may be less than zero, and the switching elements of the converting unit 110 may perform a switching operation. In a time period between the third time point T3 and the fourth time point T4, an overshoot may occur in the bulk voltage VBULK due to the inductor current IL having a magnitude smaller than zero flowing in the inductor. When an overshoot occurs in the bulk voltage VBULK, there is a challenge in that the performance of the voltage converter may be degraded. In addition, when an overshoot occurs in the bulk voltage VBULK, there is a challenge in that the performance of other external devices electrically connected to the voltage converter may be degraded.

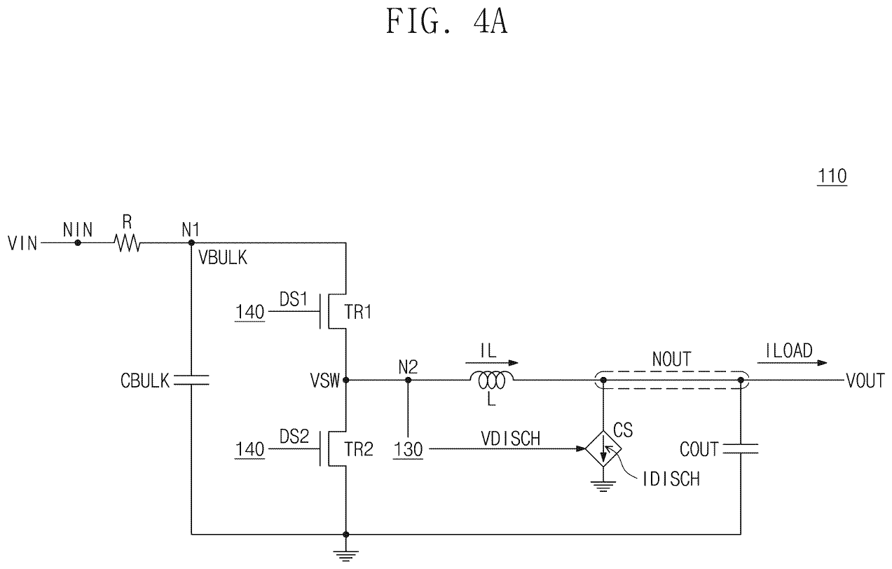

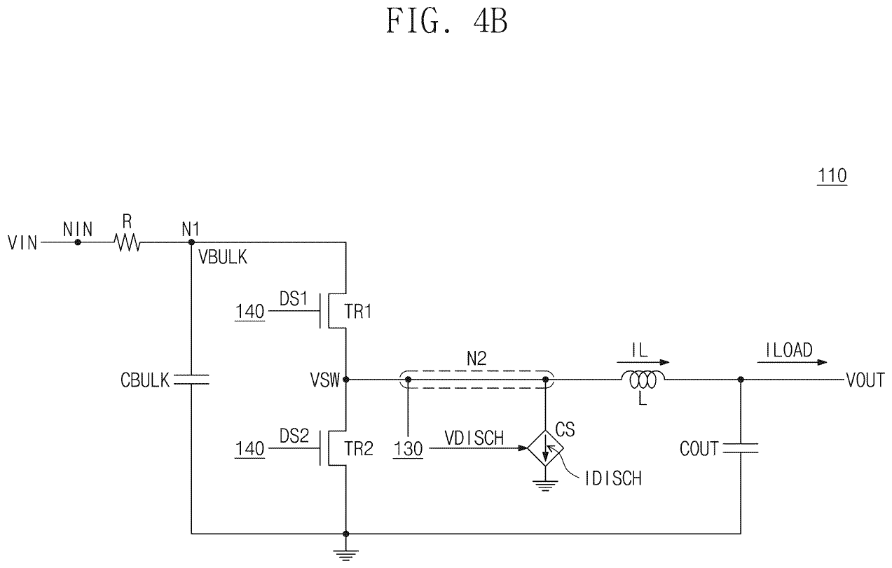

FIGS. 4A and 4B illustrate a converting unit according to embodiments of the present disclosure. Referring to FIGS. 1 and 4A, the converting unit 110 may include a resistor R, a bulk capacitor CBULK, a first switch TR1, a second switch TR2, an inductor L, an output capacitor COUT, and/or a current source CS. The converting unit 110 may also be referred to as a first circuit herein.

The resistor R may be connected between the input node NIN and the first node N1. The bulk capacitor CBULK may be connected between the first node N1 and the ground node. The first switch TR1 may be connected between the first node N1 and the second node N2. The second switch TR2 may be coupled between the second node N2 and the ground node. The inductor L may be coupled between the second node N2 and the output node NOUT. Output capacitor COUT may be coupled between output node NOUT and a ground node. The current source CS may be connected between the output node NOUT and the ground node.

The bulk capacitor CBULK may store bulk voltage VBULK. The bulk voltage VBULK may be the input voltage VIN from which a noise is removed based on the input voltage VIN being received at the input node NIN. Specifically, the resistor R and the bulk capacitor CBULK may perform low pass filtering. For example, the bulk voltage VBULK stored in the bulk capacitor CBULK may be a voltage from which an alternating current component is removed from the input voltage VIN received through the input node NIN.

The first switch TR1 may be one of a plurality of switching elements of the converting unit 110. The first switch TR1 may be turned on or turned off in response to the first drive signal DS1. The second switch TR2 may be one of the plurality of switching elements of the converting unit 110. The second switch TR2 may be turned on or off in response to the second drive signal DS2. For example, although the first switch TR1 and the second switch TR2 are illustrated as being implemented as transistors, the first switch TR1 and the second switch TR2 may be implemented as other active elements, such as diodes that are switchable according to voltage.

The first switch TR1 and the second switch TR2 may operate in response to the levels of the first drive signal DS1 and the second drive signal DS2 received from the control unit 140, respectively. For example, the first switch TR1 may be turned on in response to the first drive signal DS1 being a logical high level, and turned off in response to the first drive signal DS1 being a logical low level. For another example, the second switch TR2 may be turned on in response to the second drive signal DS2 being at a logical high level, and turned off in response to the second drive signal DS2 being at a logical low level.

The first switch TR1 and the second switch TR2 of the present disclosure are merely examples, and the scope of the present disclosure is not limited thereto. For example, it should be understood that embodiments in which at least a part of the first switch TR1 and the second switch TR2 further includes an element also fall within the scope of the present disclosure. In addition, it should be understood that embodiments in which at least some of the first switch TR1 and the second switch TR2 are turned on in response to the corresponding drive signal being at a logical low level, and are turned off in response to the respective drive signal being at the logical high level also fall within the scope of the present disclosure.

The output capacitor COUT may store the output voltage VOUT. The output voltage VOUT may be the switching voltage VSW with a noise is removed therefrom. Specifically, the inductor L and the output capacitor COUT may perform low-pass filtering. For example, the switching voltage VSW may include an alternating current component according to switching operations of the first switch TR1 and the second switch TR2. For example, the output voltage VOUT stored in the output capacitor COUT may be a voltage from which an alternating current component is removed from the switching voltage VSW.

The current source CS may operate in response to the discharge voltage VDISCH. Specifically, the active discharging unit 130 may detect the magnitude of the inductor current IL flowing in the inductor L, and generate the discharge voltage VDISCH based on the magnitude of the detected inductor current IL. For example, when the active discharging unit 130 detects that the magnitude of the inductor current IL is zero, the active discharging unit 130 may generate the discharge voltage VDISCH.

As described above, the converting unit 110 may convert the input voltage VIN into the output voltage VOUT by the switching operation of the first switch TR1 and the second switch TR2. In addition, the converting unit 110 may output the load current ILOAD through the output node NOUT. When the voltage converter 100 terminates operation, the voltage converter 100 may enter a soft-stop phase to perform a soft-stop operation.

In the soft-stop phase in which the magnitude of the inductor current IL is not zero, that is, the first switch TR1 and the second switch TR2 may maintain switching operation. For example, when the first switch TR1 and the second switch TR2 performing the switching operation before entering the soft-stop phase enter the soft-stop phase of the first condition, the first switch TR1 and the second switch TR2 may continue to perform the switching operation in response to each of the first drive signal DS1 and the second drive signal DS2 received from the control unit 140.

In the soft-stop phase of the second condition, that is, when the magnitude of the inductor current IL is zero, first switch TR1 and the second switch TR2 may stop the switching operation. For example, when the first switch TR1 and the second switch TR2 performing the switching operation before entering the soft-stop phase enter the soft-stop phase of the second condition, the first switch TR1 and the second switch TR2 may both be turned off in response to each of the first drive signal DS1 and the second drive signal DS2 of the logical low level received from the control unit 140, so that the first switch TR1 and the second switch TR2 may not perform the switching operation.

In the voltage converter 100 according to embodiments, the first switch TR1 and the second switch TR2 of the converting unit 110 may perform switching operations so that the magnitude of the inductor current IL is not smaller than zero. Specifically, when the magnitude of the inductor current IL is zero, both the first switch TR1 and the second switch TR2 are turned off, so that the second node N2 may be in a floating state. Thus, the magnitude of the inductor current IL is maintained at zero and may not decrease to a value less than zero.

The current source CS may be implemented as a dependent current source that operates based on the discharge voltage VDISCH. For example, when the discharge voltage VDISCH is received from the active discharging unit 130, the current source CS may generate the discharge current IDISCH based on the received discharge voltage VDISCH. For example, the discharge current IDISCH generated by the current source CS flows from the output node NOUT to the ground node, whereby the output voltage VOUT may be discharged. That is, in the soft-stop phase, when the discharge voltage VDISCH is received from the active discharging unit 130, the output voltage VOUT may be discharged by the discharge current IDISCH. On the other hand, when the discharge voltage VDISCH is not received from the active discharging unit 130, the output voltage VOUT may be discharged by the load current ILOAD flowing through the output node NOUT.

The converting unit 110 of FIG. 4B may be configured and operate in the same manner as (or a similar manner to) the converting unit 110 of FIG. 4A except that the current source CS is connected between the second node N2 and the ground node, and the output voltage VOUT is discharged by the discharge current IDISCH flowing from the second node N2, to the ground node. Therefore, redundant description is omitted.

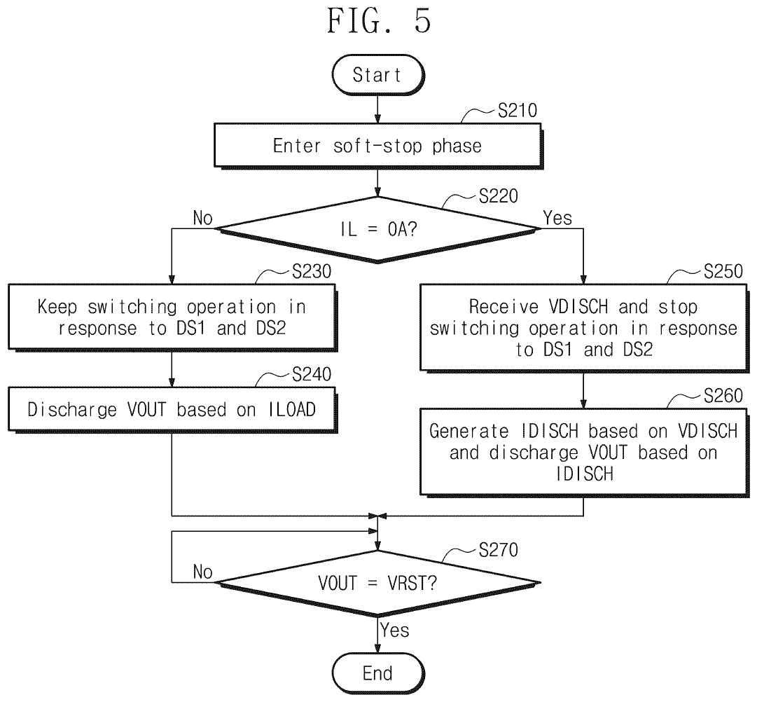

FIG. 5 illustrates an operation method of a converting unit according to embodiments of the present disclosure. Referring to FIGS. 1, 4A, 4B, and 5, in operation S210, the converting unit 110 may enter a soft-stop phase. For example, when the voltage converter 100 terminates operation, the converting unit 110 may enter the soft-stop phase and perform a soft-stop operation.

In operation S220, the converting unit 110 may determine whether the magnitude of the inductor current IL is zero. For example, the active discharging unit 130 may detect whether the magnitude of the inductor current IL flowing in the inductor L included in the converting unit 110 is zero. When the magnitude of the inductor current IL is not zero, the converting unit 110 may proceed to operation S230. When the magnitude of the inductor current IL is zero, the voltage converter 100 may proceed to operation S250.

In operation S230, the converting unit 110 may maintain the switching operation in response to the first drive signal DS1 and the second drive signal DS2. For example, the first switch TR1 and the second switch TR2 of the converting unit 110 may continue to perform the switching operation in response to the first drive signal DS1 and the second drive signal DS2 received from the control unit 140, respectively.

In operation S240, the converting unit 110 may discharge the output voltage VOUT based on the load current ILOAD. For example, when the magnitude of the inductor current IL is not zero, the output voltage VOUT of the converting unit 110 may be discharged based on the load current ILOAD flowing through the output node NOUT.

In operation S250, the converting unit 110 may receive the discharge voltage VDISCH and stop the switching operation in response to the first drive signal DS1 and the second drive signal DS2. For example, the converting unit 110 may receive the discharge voltage VDISCH from the active discharging unit 130, and the first switch TR1 and the second switch TR2 of the converting unit 110 are both turned off in response to each of the first drive signal DS1 and the second drive signal DS2 at the logical low level received from the control unit 140, thereby not performing the switching operation.

In operation S260, the converting unit 110 may generate a discharge current IDISCH based on the discharge voltage VDISCH, and discharge the output voltage VOUT based on the discharge current IDISCH. For example, when the magnitude of the inductor current IL is zero, the current source CS of the converting unit 110 generates the discharge current IDISCH based on the discharge voltage VDISCH received from the active discharging unit 130, and the output voltage VOUT of the converting unit 110 may be discharged based on the discharge current IDISCH generated by the current source CS.

In operation S270, the converting unit 110 may determine whether the output voltage VOUT is discharged to the reset voltage VRST. For example, the converting unit 110 may determine whether the output voltage VOUT is discharged to the reset voltage VRST over the soft-stop time period. When the output voltage VOUT has not been discharged to the reset voltage VRST, the soft-stop time period has not yet elapsed and the converting unit 110 may continue to perform the soft-stop operation. Accordingly, when the output voltage VOUT is not discharged to the reset voltage VRST, the converting unit 110 may return to operation S270 and repeat the above-described operations. That is, the converting unit 110 may not terminate the soft-stop operation until the output voltage VOUT is detected to be equal to (or similar to) the reset voltage VRST by the discharge operation on the output voltage VOUT according to operation S240 or operation S260. When the output voltage VOUT is discharged to the reset voltage VRST, the soft-stop time period may elapse and the soft-stop phase may be terminated. Thus, when the output voltage VOUT is discharged to the reset voltage VRST, the converting unit 110 may terminate the soft-stop operation.

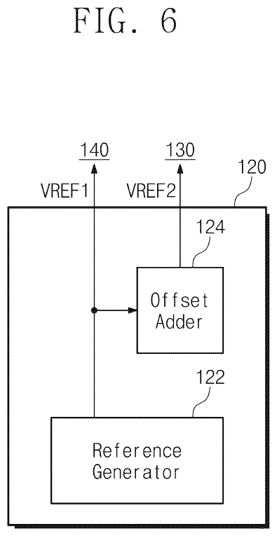

FIG. 6 illustrates a reference generating unit according to embodiments of the present disclosure. Referring to FIGS. 1 and 6, the reference generating unit 120 may include a reference generator 122 and/or an offset adder 124.

The reference generator 122 may generate a first reference voltage VREF1. The reference generator 122 may transmit the generated first reference voltage VREF1 to the control unit 140. For example, the first reference voltage VREF1 generated by the reference generator 122 may be a reference of the switching operation performed by a plurality of switching elements of the converting unit 110. Specifically, the plurality of switching elements of the converting unit 110 may perform a switching operation such that the output voltage VOUT is not less than the first reference voltage VREF1. That is, by the switching operation of the plurality of switching elements of the converting unit 110, the output voltage VOUT may be maintained so as not to be smaller than the first reference voltage VREF1.

Offset adder 124 may receive a first reference voltage VREF1 from reference generator 122, and generate a second reference voltage VREF2 based on the received first reference voltage VREF1. For example, the second reference voltage VREF2 that the offset adder 124 generates may be the first reference voltage VREF1 plus the offset voltage. Thus, the second reference voltage VREF2 may be greater than the first reference voltage VREF1. The offset adder 124 may transmit the generated second reference voltage VREF2 to the active discharging unit 130. For example, the second reference voltage VREF2 generated by the offset adder 124 may be a reference for an active discharge operation performed by the active discharging unit 130 and the current source CS of the converting unit 110. Specifically, the active discharging unit 130 may control the active discharge operation such that the output voltage VOUT is smaller than the second reference voltage VREF2. That is, based on the discharge voltage VDISCH generated by the active discharging unit 130, the current source CS may generate the discharge current IDISCH, thereby maintaining the output voltage VOUT to be smaller than the second reference voltage VREF2.

Before the voltage converter 100 enters the soft-stop phase, the first reference voltage VREF1 and the second reference voltage VREF2 output by the reference generating unit 120 may be maintained at a constant level. For example, before the voltage converter 100 enters the soft-stop phase, the first reference voltage VREF1, the offset voltage, and the second reference voltage VREF2 may be maintained at a constant level.

When the voltage converter 100 enters the soft-stop phase, the first reference voltage VREF1 and the second reference voltage VREF2 output by the reference generation unit 120 may decrease to the reset voltage VRST over a soft-stop time period. For example, when the voltage converter 100 enters the soft-stop phase, the first reference voltage VREF1 may decrease to the reset voltage VRST over a soft-stop time period, the offset voltage may decrease to zero over the soft-stop time period, and the second reference voltage VREF2 may decrease to the set voltage VRST over the soft-stop time period.

After the voltage converter 100 performs a soft-stop operation over the soft-stop time period, the soft-stop phase of the voltage converter 100 may be terminated, and both the first reference voltage VREF1 and the second reference voltage VREF2 may be in a state of decreasing to the reset voltage VRST. Therefore, the output voltage VOUT of the voltage converter 100 may also be in a state of being discharged to the reset voltage VRST.

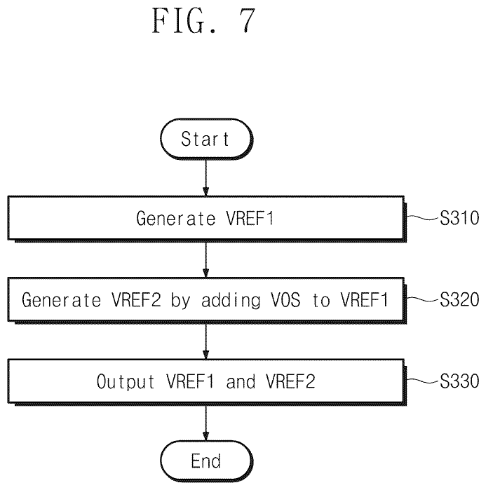

FIG. 7 illustrates an operation method of a reference generating unit 120 according to embodiments of the present disclosure. Referring to FIGS. 1, 6, and 7, in operation S310, the reference generating unit 120 may generate a first reference voltage VREF1. For example, the reference generator 122 of the reference generation unit 120 may generate the first reference voltage VREF1.

In operation S320, the reference generating unit 120 may generate the second reference voltage VREF2 by adding the offset voltage VOS to the first reference voltage VREF1. For example, the offset adder 124 of the reference generating unit 120 may add the offset voltage VOS to the first reference voltage VREF1 received from the reference generator 122 to generate the second reference voltage VREF2.

In operation S330, the reference generating unit 120 may output the first reference voltage VREF1 and the second reference voltage VREF2. For example, the reference generator 122 of the reference generating unit 120 may output the generated first reference voltage VREF1 to the control unit 140, and the offset adder 124 of the reference generating unit 120 may output the generated second reference voltage VREF2 to the active discharging unit 130.

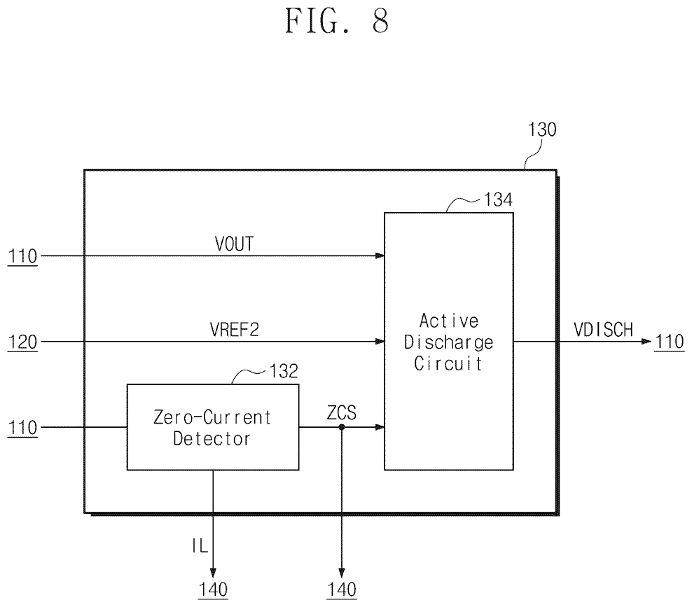

FIG. 8 illustrates an active discharging unit 130 according to embodiments of the present disclosure. Referring to FIGS. 1 and 8, the active discharging unit 130 may include a zero-current detector 132 and/or an active discharge circuit 134.

The zero-current detector 132 may detect the magnitude of the inductor current IL flowing in the inductor L of the converting unit 110. For example, the zero-current detector 132 may detect whether the magnitude of the inductor current IL is zero. The zero-current detector 132 may generate a zero-current signal ZCS based on a sensing result of the magnitude of the inductor current IL. For example, when the magnitude of the inductor current IL is detected to be non-zero, the zero-current signal ZCS may be a signal at a logical low level, or when the magnitude of inductor current IL is detected to be zero, the zero-current signal ZCS may a signal at a logical high level. The zero-current detector 132 may transmit the generated zero-current signal ZCS to the active discharge circuit 134. In addition, the zero-current detector 132 may transmit the magnitude of the detected inductor current IL and the generated zero-current signal ZCS to the control unit 140.

The active discharge circuit 134 may receive the zero-current signal ZCS from the zero-current detector 132, receive the output voltage VOUT from the converting unit 110, and receive the second reference voltage VREF2 from the reference generation unit 120. The active discharge circuit 134 may generate a discharge voltage VDISCH based on the zero-current signal ZCS, the output voltage VOUT, and the second reference voltage VREF2. The active discharge circuit 134 may transmit the generated discharge voltage VDISCH to the converting unit 110.

For example, whether the active discharge circuit 134 generates the discharge voltage VDISCH may be determined according to the level of the zero-current signal ZCS. In other words, the zero-current signal ZCS may be an enable signal that determines whether to operate the active discharge circuit 134. Specifically, the active discharge circuit 134 may generate the discharge voltage VDISCH based on the output voltage VOUT and the second reference voltage VREF2, in response to the zero-current signal ZCS of the logical high level. Further, the active discharge circuit 134 may not generate the discharge voltage VDISCH in response to the zero-current signal ZCS at the logical low level. That is, the active discharge circuit 134 may generate the discharge voltage VDISCH when the magnitude of the inductor current IL is zero, and may not generate the discharge voltage VDISCH when it is not zero.

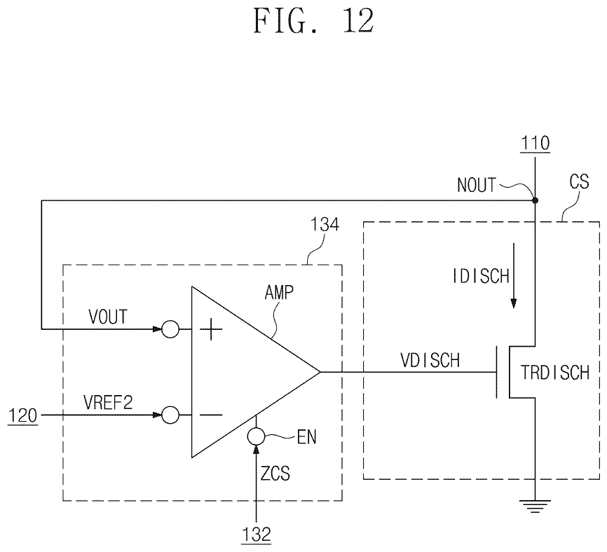

When the zero-current signal ZCS is a signal of a logical high level, the active discharging unit 130 may generate the discharge voltage VDISCH based on a difference between the second reference voltage VREF2 and the output voltage VOUT. For example, when the difference between the second reference voltage VREF2 and the output voltage VOUT is smaller than a specific value, the active discharging unit 130 may generate the discharge voltage VDISCH. As another example, when the difference between the second reference voltage VREF2 and the output voltage VOUT is greater than a specific value, the active discharging unit 130 may not generate the discharge voltage VDISCH. A specific operation in which the active discharge circuit 134 generates the discharge voltage VDISCH will be described below with reference to FIG. 12.

The zero-current signal ZCS described herein is illustrative and the scope of the present disclosure is not limited thereto. For example, the zero-current signal ZCS may be implemented to be a logical high level signal when the magnitude of the inductor current IL is detected to be non-zero, and a logical low level signal when it is detected that the magnitude of the current IL is zero.

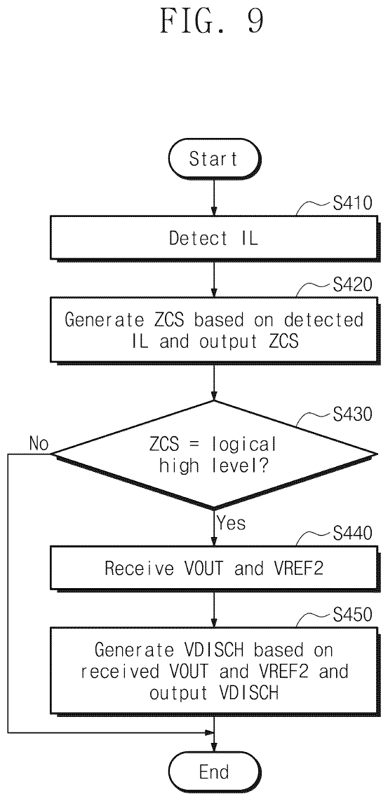

FIG. 9 illustrates an operation method of an active discharging unit 130 according to embodiments of the present disclosure. Referring to FIGS. 1, 8, and 9, in operation S410, the active discharging unit 130 may detect the magnitude of the inductor current IL. For example, the zero-current detector 132 of the active discharging unit 130 may detect the magnitude of the inductor current IL flowing in the inductor L of the converting unit 110.

In operation S420, the active discharging unit 130 may generate the zero-current signal ZCS based on the detected magnitude of the inductor current IL, and output the zero-current signals ZCS. Here, the zero-current signal ZCS may be a signal of a logical low level when the magnitude of the inductor current IL is not zero, and a signal of a logical high level when the magnitude thereof is zero. For example, the zero-current detector 132 of the active discharging unit 130 may generate the zero-current signal ZCS based on the magnitude of the detected inductor current IL, and transmit the generated zero-current signal ZCS to the active discharge circuit 134.

In operation S430, the active discharging unit 130 may determine the level of the zero-current signal ZCS. For example, the active discharge circuit 134 may determine whether the received zero-current signal ZCS is at a logical high level. When the zero-current signal ZCS is at a logical low level, the active discharging unit 130 may terminate the operation. When the zero-current signal ZCS is at the logical high level, the active discharging unit 130 may proceed to operation S440.

In operation S440, the active discharging unit 130 may receive the output voltage VOUT and the second reference voltage VREF2. For example, the active discharge circuit 134 of the active discharging unit 130 may receive the output voltage VOUT from the converting unit 110 and receive the second reference voltage VREF2 from the reference generation unit 120.

In operation S450, the active discharging unit 130 may generate the discharge voltage VDISCH based on the received output voltage VOUT and the second reference voltage VREF2, and may output the discharge voltage VDISCH. For example, the active discharge circuit 134 of the active discharging unit 130 may generate the discharge voltage VDISCH based on the difference between the received second reference voltage VREF2 and the output voltage VOUT, and transmit the generated discharge voltage VDISCH to the converting unit 110.

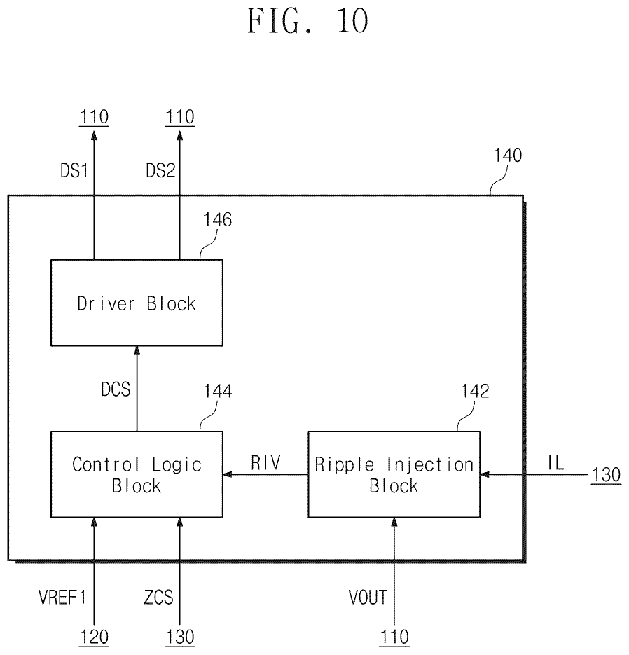

FIG. 10 illustrates a control unit according to embodiments of the present disclosure. Referring to FIGS. 1 and 10, the control unit 140 may include a ripple injection block 142, a control logic block 144, and/or a driver block 146.

The control unit 140 may receive the output voltage VOUT from the converting unit 110, receive the first reference voltage VREF1 from the reference generating unit 120, and receive the magnitude of the detected inductor current IL and/or the zero-current signal ZCS from the active discharging unit 130.

The ripple injection block 142 may generate a ripple injected voltage RIV corresponding to the output voltage VOUT based on the output voltage VOUT received from the control unit 140 and the magnitude of the inductor current IL received from the active discharging unit 130. For example, the ripple injected voltage RIV may be a voltage that adds the ripple voltage to the output voltage VOUT. Here, the ripple voltage may include an alternating current component. The ripple injection block 142 may send the generated ripple injected voltage RIV to the control logic block 144.

The control logic block 144 may generate the driver control signal DCS based on the first reference voltage VREF1 received from the reference generating unit 120, the zero-current signal ZCS received from the active discharging unit 130, and the ripple injected voltage RIV received from the ripple injection block 142. For example, the control logic block 144 may generate a driver control signal DCS for stopping the switching operation of the plurality of switching elements of the converting unit 110 when the zero-current signal ZCS is at a logical high level. For example, the control logic block 144 may generate the driver control signal DCS for performing the switching operation of the plurality of switching elements of the converting unit 110 based on a result of comparing the first reference voltage VREF1 and the ripple injected voltage RIV. The control logic block 144 may send the generated driver control signal DCS to the driver block 146.

For example, the ripple injected voltage RIV may be a voltage for accurately comparing the first reference voltage VREF1 and the output voltage VOUT. Specifically, the control unit 140 may indirectly compare the first reference voltage VREF1 and the output voltage VOUT by comparing the first reference voltage VREF1 and the ripple injected voltage RIV. That is, the control unit 140 may control switching operations of the plurality of switching elements of the converting unit 110 based on a result of indirectly comparing the first reference voltage VREF1 and the output voltage VOUT. Here, in order to improve a stability of the switching operation, the ripple injected voltage RIV corresponding to the output voltage VOUT may be compared with the first reference voltage VREF1. Thus, hereinafter, the operation of comparing the first reference voltage VREF1 and the ripple injected voltage RIV will be understood to correspond to the operation of comparing first reference voltage VREF1 and the output voltage VOUT.

The driver block 146 may generate the first drive signal DS1 and the second drive signal DS2 based on the driver control signal DCS received from the control logic block 144. The driver block 146 may transmit the first drive signal DS1 and the second drive signal DS2 to the plurality of switching elements of the converting unit 110. For example, the driver block 146 may control the switching operations of the plurality of switching elements of the converting unit 110 based on the first drive signal DS1 and the second drive signal DS2.

Referring to FIGS. 1, 4A, 4B, and 10, the difference between the ripple injected voltage RIV and the switching voltage VSW may be less than the difference between the output voltage VOUT and the switching voltage VSW. The ripple injection block 142 may improve a stability of the switching operations of the first switch TR1 and the second switch TR2. For example, a switching operation of the first switch TR1 and the second switch TR2 based on a result of the control logic block 144 comparing the first reference voltage VREF1 and the ripple injected voltage RIV may provide the improved stability as compared to a switching operation of first switch TR1 or second switch TR2 that is based on a direct comparison of the first reference voltage VREF1 and the output voltage VOUT.

When the first switch TR1 and the second switch TR2 perform a switching operation, the first switch TR1 may be turned on and the second switch TR2 may be turned off during an on time period TON. Then, the first switch TR1 turned on during the on time period TON may be turned off again, and the second switch TR2 turned off during the on time period TON may be turned on. Here, the on time period TON may be determined based on the input voltage VIN received by the voltage converter 100 and the output voltage VOUT output to the load. For example, the on time period TON may correspond to the duty ratio of the switching operation of the voltage converter 100. The voltage converter 100 may increase the on time period TON, thereby increasing the output voltage VOUT, or decrease the on time period TON, thereby decreasing the output voltage VOUT.

If the zero-current signal ZCS is at a logical high level, the control logic block 144 may generate a driver control signal DCS to stop switching operations of the first switch TR1 and the second switch TR2. For example, the driver block 146 may generate the first drive signal DS1 and the second drive signal DS2 at a logical low level based on the driver control signal DCS. The first switch TR1 and the second switch TR2 may both be turned off in response to the first drive signal DS1 and the second drive signal DS2 at the logical low level, respectively.

If the zero-current signal ZCS is at a logical low level, the control logic block 144 may generate a driver control signal DCS to maintain switching operation of the first switch TR1 and the second switch TR2. For example, the control logic block 144 may control the first switch TR1 and the second switch TR2 to perform the switching operation once in response to the first reference voltage VREF1 and the ripple injected voltage RIV being equal. That is, each time the control logic block 144 responds that the first reference voltage VREF1 and the ripple injected voltage RIV are equal, the first switch TR1 and the second switch TR2 may repeatedly perform the switching operation once.

For example, the driver block 146 may generate the logical high level first drive signal DS1 and the logical low level second drive signal DS2 based on the driver control signal DCS for maintaining switching operations of the first switch TR1 and the second switch TR2. Further, the driver block 146 may change the first drive signal DS1 to a logical low level and may change the second drive signal DS2 to a logical high level after the on time period TON.

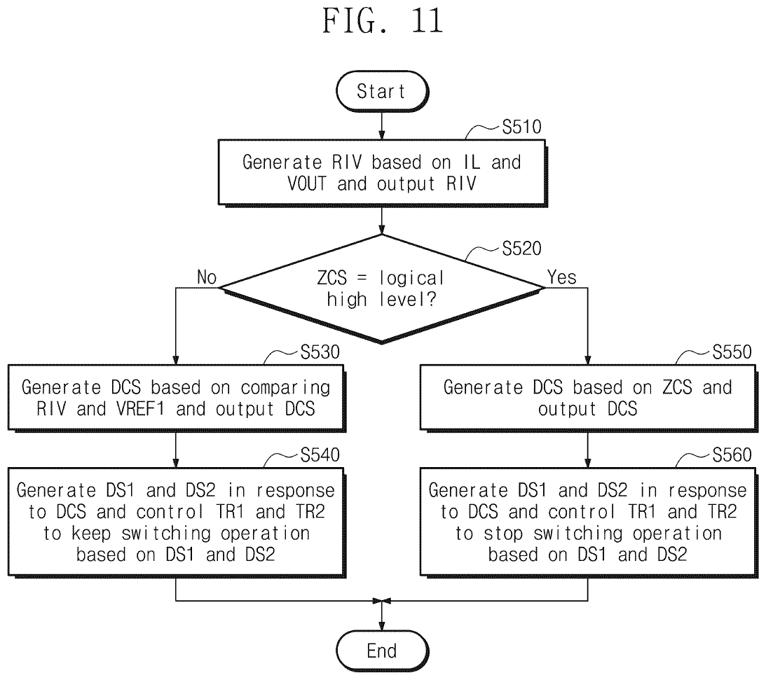

FIG. 11 illustrates an operation method of a control unit 140 according to embodiments of the present disclosure. Referring to FIGS. 10 and 11, in operation S510, the control unit 140 may generate a ripple injected voltage RIV based on the magnitude of the inductor current IL and the output voltage VOUT, and output the ripple injected voltage RIV. For example, the ripple injection block 142 of the control unit 140 may generate the ripple injected voltage RIV based on the magnitude of the inductor current IL received from the active discharging unit 130 and the output voltage VOUT received from the converting unit 110, and transmit the generated ripple injected voltage RIV to the control logic block 144.

In operation S520, the control unit 140 may determine a level of the zero-current signal ZCS. For example, the control logic block 144 of the control unit 140 may determine whether the zero-current signal ZCS received from the active discharging unit 130 is at a logical high level. If the zero-current signal ZCS is at a logical low level, the control unit 140 may proceed to operation S530. If the zero-current signal ZCS is at a logical high level, the control unit 140 may proceed to operation S550.

In operation S530, the control unit 140 may generate the driver control signal DCS based on comparing the ripple injected voltage RIV and the first reference voltage VREF1, and output the driver control signal DCS. For example, the control logic block 144 of the control unit 140 may generate the driver control signal DCS based on a result of comparing the ripple injected voltage RIV received from the ripple injection block 142 and the first reference voltage VREF1 received from the reference generating unit 120, and transmit the generated driver control signal DCS to the driver block 146.

In operation S540, the control unit 140 may generate a first drive signal DS1 and a second drive signal DS2 in response to the driver control signal DCS, and control the first switch TR1 and the second switch TR2 to maintain a switching operation based on the first drive signal DS1 and the second drive signal DS2. For example, the driver block 146 of the control unit 140 may generate the first drive signal DS1 and the second drive signal DS2 in response to the driver control signal DCS received from the control logic block 144, and control the first switch TR1 and the second switch TR2 of the converting unit 110 to continue performing the switching operation based on the generated first drive signal DS1 and second drive signal DS2.

In operation S550, the control unit 140 may generate the driver control signal DCS based on the zero-current signal ZCS, and output the driver control signal DCS. For example, the control logic block 144 of the control unit 140 may generate a driver control signal DCS based on the zero-current signal ZCS received from the active discharging unit 130, and output the generated driver control signal DCS to the driver block 146.

In operation S560, the control unit 140 may generate the first drive signal DS1 and the second drive signal DS2 in response to the driver control signal DCS, and control the first switch TR1 and the second switch TR2 to stop the switching operation based on the first drive signal DS1 and the second drive signal DS2. For example, the driver block 146 of the control unit 140 may generate the first drive signal DS1 and the second drive signal DS2 in response to the driver control signal DCS received from the control logic block 144, and control the first switch TR1 and the second switch TR2 of the converting unit 110 not to perform a switching operation based on the generated first drive signal DS1 and second drive signal DS2.

For example, operations S530 to S540 may correspond to operations in which the control unit 140 performs a soft-stop operation in the soft-stop phase of the first condition, and operations S550 to S560 may correspond to operations of the control unit 140 performing a soft-stop operation in the soft-stop phase of the second condition. The output voltage VOUT is discharged to the reset voltage VRST according to any one of operations S530 to S540 and operations S550 to S560, and the control unit 140 may terminate the operation.

For example, according to the operation method illustrated in FIG. 11, the time period from the time point when the control unit 140 starts the soft-stop operation to the time point when the soft-stop operation is terminated may correspond to a soft-stop time period.

FIG. 12 illustrates a more detailed example of an active discharge circuit and a current source according to embodiments of the present disclosure. Referring to FIGS. 1, 4A, 4B, 8, and 12, the active discharge circuit 134 may be implemented with an amplifier AMP and the current source CS may be implemented with a discharge transistor TRDISCH.

The amplifier AMP may include a non-inverting terminal that receives the output voltage VOUT from the converting unit 110, an inverting terminal that receives the second reference voltage VREF2 from the reference generation unit 120, an enable terminal EN that receives the zero-current signal ZCS from the zero-current detector 132, and an output terminal that provides the discharge voltage VDISCH to the current source CS.

The amplifier AMP may be enabled in response to the logical high level zero-current signal ZCS. For example, when the zero-current signal ZCS is a signal of a logical low level, the amplifier AMP does not operate, and when the zero-current signal ZCS is the signal of the logical high level, the amplifier AMP may operate. That is, the zero-current signal may be used as an enable signal of the active discharge circuit 134.

Thus, the voltage converter 100 may perform a seamless soft-stop operation in the soft-stop phase. Specifically, whether to operate the active discharge circuit 134 is determined according to the zero-current signal ZCS indicating whether the magnitude of the inductor current IL is zero, so that the voltage converter 100 may perform, in the soft-stop phase, a soft-stop operation without a separate mode conversion operation for each of the first condition and the second condition.

Even if the zero-current signal ZCS is a signal at a logical high level, when the difference between the second reference voltage VREF2 and the output voltage VOUT is greater than a certain value, the amplifier AMP may not operate. That is, if the zero-current signal ZCS is a signal of a logical high level, and the difference between the second reference voltage VREF2 and the output voltage VOUT is less than a certain value, the amplifier AMP may generate the discharge voltage VDISCH. Here, the specific value may be a value corresponding to an Input Differential Range (or an input voltage range) of the amplifier AMP.

For example, if the difference between the output voltage VOUT received at the non-inverting terminal of the amplifier AMP and the second reference voltage VREF2 received at the inverting terminal is less than the input differential range of the amplifier amp, the amplifier AMP may operate linearly and provide the discharge voltage VDISCH to the current source CS. As another example, if the difference between the output voltage VOUT received at the non-inverting terminal of the amplifier AMP and the second reference voltage VREF2 received at the inverting terminal is greater than the input differential range of the amplifier amp, the amplifier AMP may operate non-linearly or reach an output saturation state, and not provide the discharge voltage VDISCH to the current source CS.

In the soft-stop phase, when the zero-current signal ZCS is a signal of a logical high level, and the difference between the output voltage VOUT and the second reference voltage VREF2 is greater than the input differential range of the amplifier AMP, the current source CS does not generate the discharge current IDISCH, and the load current ILOAD flowing through the output node NOUT of the converting unit 110 may not discharge the output voltage VOUT. In this case, in the soft-stop phase, the second reference voltage VREF2 decreases to the reset voltage VRST over a soft-stop time period, while the output voltage VOUT may be maintained as constant or overshoot. Thus, the difference between the output voltage VOUT and the second reference voltage VREF2 may be reduced.

When the difference between the output voltage VOUT and the second reference voltage VREF2 decreases to be less than the input differential range of the amplifier AMP, the amplifier AMP may generate the discharge voltage VDISCH based on the difference between the input voltage VOUT and second reference voltage VREF2. The amplifier AMP provides the discharge voltage VDISCH to the current source CS, and the current source CS may generate the discharge current IDISCH based on the discharge voltage VDISCH. Accordingly, the converting unit 110 may perform an active discharge operation of discharging the output voltage VOUT based on the discharge current IDISCH.

The discharge transistor TRDISCH may include one end connected to the output node NOUT, the other end connected to the ground node, and a gate terminal connected to the active discharge circuit 134. The discharge transistor TRDISCH may generate a discharge current IDISCH based on the discharge voltage VDISCH provided from the amplifier AMP. In the soft-stop phase of the second condition, the discharge transistor TRDISCH may discharge the output voltage VOUT based on the discharge current IDISCH.

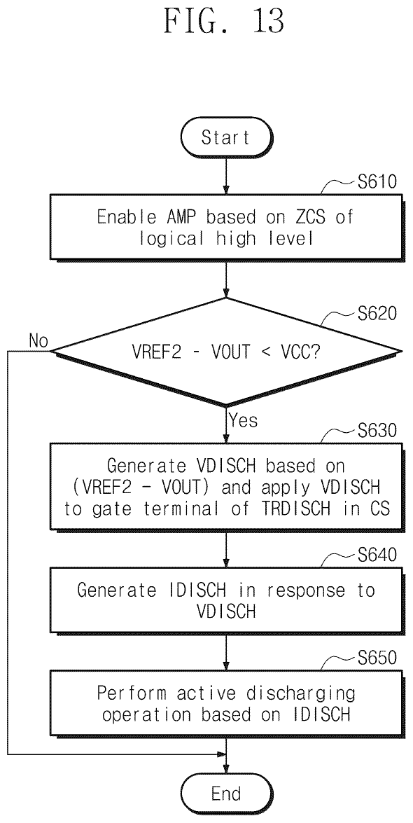

FIG. 13 illustrates an operation method of an active discharge circuit and a current source according to embodiments of the present disclosure. Referring to FIGS. 12 and 13, in operation S610, the active discharging unit 130 may enable the amplifier AMP based on the logical high level zero-current signal ZCS. For example, the active discharge circuit 134 of the active discharging unit 130 may enable the amplifier AMP based on the logical high level zero-current signal ZCS received from the zero-current detector 132.

In operation S620, the active discharging unit 130 may determine whether the difference between the second reference voltage VREF2 and the output voltage VOUT is less than a particular value. For example, the active discharge circuit 134 of the active discharging unit 130 may determine whether the difference between the second reference voltage VREF2 and the output voltage VOUT is less than the input differential range VCC of the amplifier AMP. When the difference between the second reference voltage VREF2 and the output voltage VOUT is greater than (or equal to) the input differential range VCC of the amplifier AMP, the active discharging unit 130 may terminate the operation. When the difference between the second reference voltage VREF2 and the output voltage VOUT is smaller than the input differential range VCC of the amplifier AMP, the active discharging unit 130 may proceed to operation S630.

In operation S630, the active discharging unit 130 may generate the discharge voltage VDISCH based on the difference between the second reference voltage VREF2 and the output voltage VOUT, and may apply the discharge voltage VDISCH to the gate end of the discharge transistor TRDISCH in the current source CS. For example, the amplifier AMP of the active discharging unit 130 may generate the discharge voltage VDISCH based on the difference between the second reference voltage VREF2 received from the reference generation unit 120 and the output voltage VOUT received from the converting unit 110, and apply the generated discharge voltage VDISCH to the gate end of the discharge transistor TRDISCH in the current source CS.

At operation S640, the current source CS may generate a discharge current IDISCH in response to the discharge voltage VDISCH. For example, the discharge transistor TRDISCH of the current source CS may generate the discharge current IDISCH (e.g., may cause the discharge current IDISCH by connecting the output node NOUT to the ground node) in response to the discharge voltage VDISCH received from the amplifier AMP through the gate end.

In operation S650, the voltage converter 100 may perform an active discharge operation based on the discharge current IDISCH. For example, in the soft-stop phase of the second condition, the output voltage VOUT may be discharged (e.g., connected to the ground node) based on the discharge current IDISCH generated by the discharge transistor TRDISCH of the current source CS.

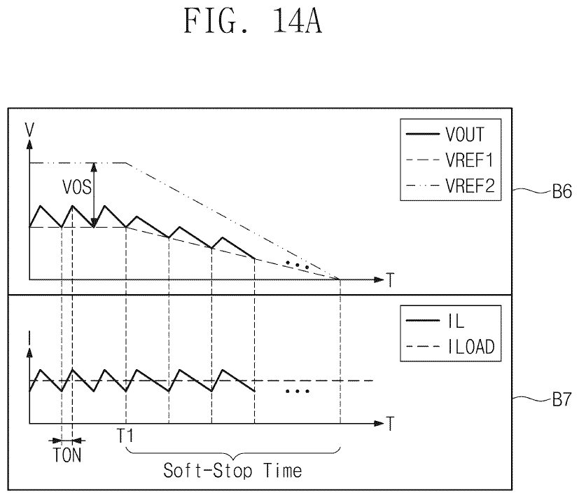

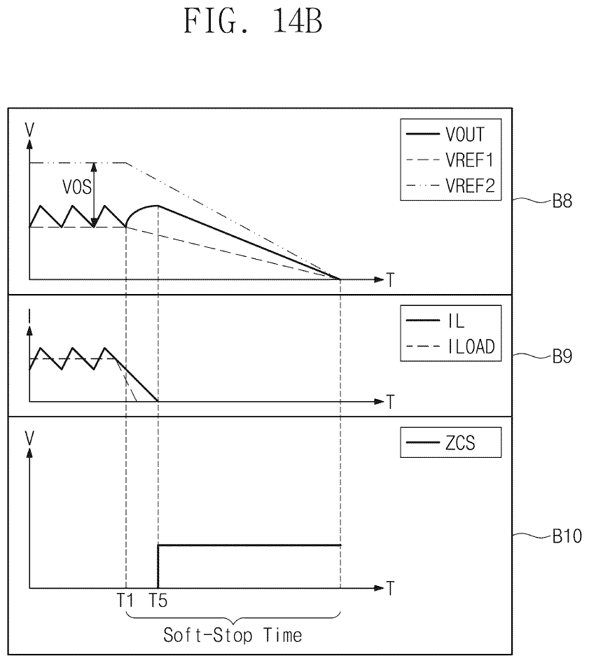

FIGS. 14A and 14B illustrate examples of a first condition and a second condition of a voltage converter according to embodiments of the present disclosure. Referring to FIG. 14A, for example, an example of the output voltage VOUT, the first reference voltage VREF1, the second reference voltage VREF2, the inductor current IL, and the load current ILOAD over time in the soft-stop phase of the first condition is illustrated. Referring to FIG. 14B, as an example, an example of the output voltage VOUT, the first reference voltage VREF1, the second reference voltage VREF2, the inductor current IL, the load current ILOAD, and the zero-current signal ZCS over time in the soft-stop phase of the second condition is illustrated.

The sixth box B6 illustrates the change of the output voltage VOUT, the first reference voltage VREF1, and the second reference voltage VREF2 in the soft-stop phase of the first condition. The seventh box B7 illustrates the change of the inductor current IL and the load current ILOAD in the soft-stop phase of the first condition. An eighth box B8 illustrates the change of the output voltage VOUT, the first reference voltage VREF1, and the second reference voltage VREF2 in the soft-stop phase of the second condition. The ninth box B9 illustrates the change of the inductor current IL and the load current ILOAD in the soft-stop phase of the second condition. The tenth box B10 illustrates the change of the zero-current signal ZCS in the soft-stop phase of the second condition. In FIGS. 14A and 14B, the horizontal axis of the sixth box B6, the eighth box B8, and the tenth box B10 indicates time T, and the vertical axis indicates voltage V. Further, in FIGS. 14A and 14B, the horizontal axis of the seventh box B7 and the ninth box B9 indicates time T, and the vertical axis indicates current I.

Referring to FIG. 14A, the voltage converter 100 according to embodiments of the present disclosure may include a second reference voltage VREF2 which is obtained by adding the offset voltage VOS to the first reference voltage VREF1. When operating in the soft-stop phase of the first condition, the voltage converter 100 according to embodiments may operate the same as (or similar to) the voltage converter according to the example discussed in connection with FIG. 3A. Therefore, redundant description is omitted.

That is, in the soft-stop phase of the first condition, the plurality of switching elements continue to perform the switching operation, and the output voltage VOUT may be discharged by the load current ILOAD.

Referring to FIG. 14B, the voltage converter 100 according to embodiments of the present disclosure may perform a switching operation before the first time point T1. The voltage converter 100 before the first time point T1 in FIG. 14B may perform a switching operation corresponding to the first reference voltage VREF1, similarly to the voltage converter 100 before a first time point T1 of FIG. 14A. The zero-current signal ZCS may also be a logical low level signal.

At a first time point T1, the voltage converter 100 may enter a soft-stop phase of a second condition. For example, the voltage converter 100 may operate in the soft-stop phase for a soft-stop time period after the first time point T1. In the soft-stop phase of the second condition, the voltage converter 100 may turn off the plurality of switching elements. In the soft-stop phase, the first reference voltage VREF1 and the second reference voltage VREF2 may be reduced to the reset voltage VRST over a soft-stop time period.

In a time period between the first time point T1 and the fifth time point T5, the magnitude of the inductor current IL and the magnitude of the load current ILOAD may decrease. In addition, the output voltage VOUT may overshoot (e.g., become higher than desired or intended) without being discharged. In FIG. 14B, in the time period between the first time point T1 and the fifth time point T5, the output voltage VOUT is illustrated as overshooting, but this is illustrative and the present disclosure is not limited thereto. For example, in the time period between the first time point T1 and the fifth time point T5, the output voltage VOUT is not discharged and may be kept constant. In the time period between the first time point T1 and the fifth time point T5, the zero-current signal ZCS may be a signal at a logical low level.

At the fifth time point T5, the magnitude of the inductor current IL becomes zero, and the zero-current signal ZCS may change to a logical high level. At the fifth time point T5, the voltage converter 100 may generate a discharge voltage VDISCH based on the logical high level zero-current signal ZCS. Specifically, at the fifth time point T5, the difference between the second reference voltage VREF2 and the output voltage VOUT of the voltage converter 100 may be less than the input differential range VCC of the amplifier AMP of the active discharging unit 130. The current source CS of the voltage converter 100 may generate a discharge current IDISCH in response to the discharge voltage VDISCH and perform an active discharge operation based on the generated discharge current IDISCH. The voltage converter 100 may discharge the output voltage VOUT to the reset voltage VRST based on the discharge current IDISCH.

In FIG. 14B, for convenience of description, the difference between the second reference voltage VREF2 and the output voltage VOUT at the fifth time point T5 is illustrated assuming that the difference is smaller than the input differential range VCC of the amplifier AMP of the active discharging unit 130 as an example, but the scope of the present disclosure is not limited thereto. For example, at the fifth time point T5, even if the zero-current signal ZCS is at a logical high level, the difference between the second reference voltage VREF2 and the output voltage VOUT may be greater than the input differential range VCC of the amplifier AMP of the active discharging unit 130. In this case, the difference between the second reference voltage VREF2 and the output voltage VOUT becomes smaller than the input differential range VCC of the amplifier AMP of the active discharging unit 130 as a result of the decrease in the second reference voltage VREF2 over time, and the amplifier AMP may generate the discharge voltage VDISCH.

In FIG. 14B, before the first time point T1, the magnitude of the load current ILOAD is illustrated to be sufficient to discharge the output voltage VOUT, but this is illustrative and the present disclosure is not limited thereto. For example, prior to the first time point T1, the magnitude of the load current ILOAD may not be sufficient to discharge the output voltage VOUT, similar to the voltage converter of FIG. 3B.

During the soft-stop time period, the output voltage VOUT may be equal to or greater than the first reference voltage VREF1, and less than the second reference voltage VREF2. After the soft-stop time period elapses from the first time point T1, the first reference voltage VREF1, the second reference voltage VREF2, and the output voltage VOUT may all be the reset voltage VRST. Specifically, the voltage converter 100 according to embodiments may accurately control the time period for performing the soft-stop operation, that is, the soft-stop time period.

Further, in the voltage converter 100 according to embodiments, in the soft-stop phase of the second condition, the magnitude of the inductor current IL may not be smaller than zero. Specifically, in the soft-stop phase of the second condition, the voltage converter 100 according to embodiments may not overshoot the bulk voltage VBULK. Therefore, performance of the voltage converter 100 or other devices externally connected to the voltage converter 100 may not be degraded (or may be less degraded relative to the example discussed in connection with FIG. 3B).

The operation in the soft-stop phase of the voltage converter 100 according to embodiments of the present disclosure has been described above with reference to FIGS. 1, 2, and 4A to 14B. Specifically, the voltage converter 100 may operate in the soft-stop phase of the first condition (or the heavy load condition) or the soft-stop phase of the second condition (or the light load condition) based on the magnitude of the inductor current IL, so as to accurately control a soft-stop time period.

For example, in the foregoing, it has been described that in the soft-stop phase of the second condition, the output voltage VOUT is not discharged to the first reference voltage VREF1 before the soft-stop operation is terminated. For example, in the soft-stop phase of the second condition, the output voltage VOUT has been described as being discharged to the first reference voltage VREF1, which has been reduced to the reset voltage VRST, at the same time period (or point) as (or a similar time period or point to) a time period (or point) at which the soft-stop operation is terminated.

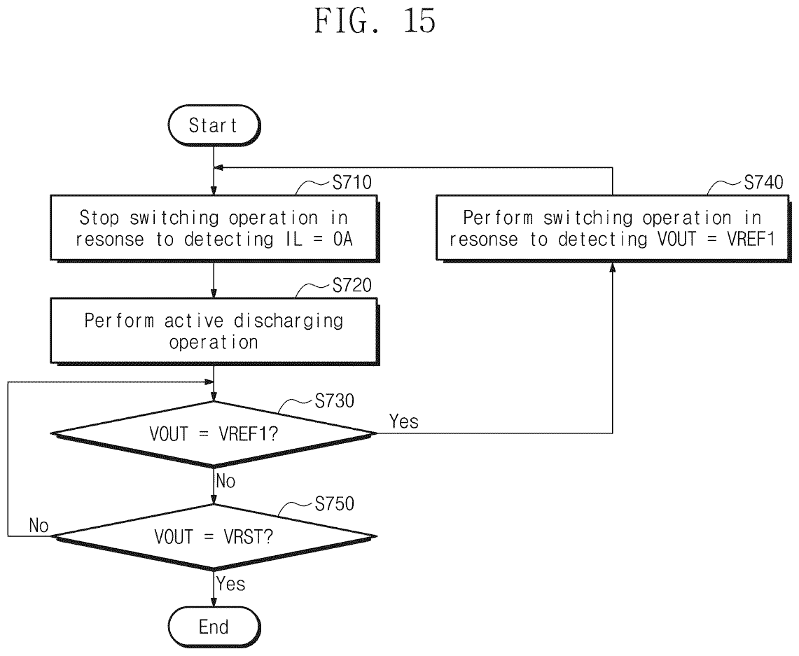

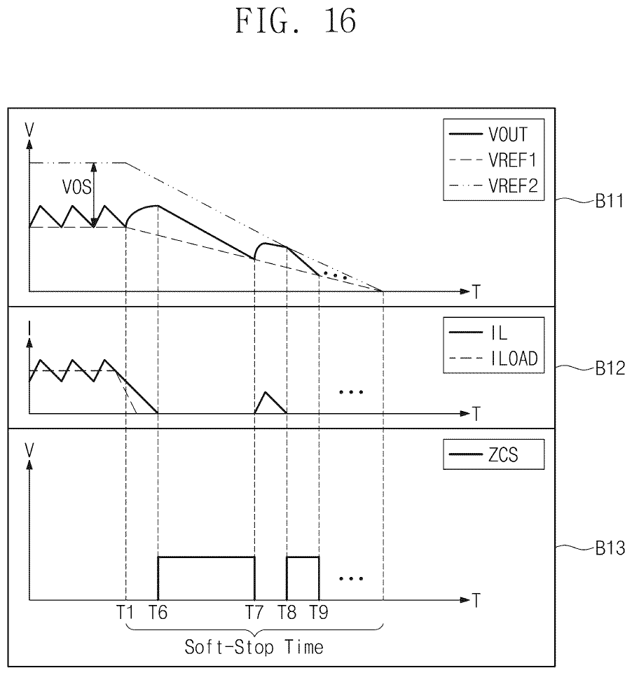

However, this is illustrative, and the scope of the present disclosure is not limited thereto. For example, depending on the magnitude of the load current ILOAD, the magnitude of the discharge current IDISCH, and the like, the output voltage VOUT may be discharged to the first reference voltage VREF1 before the soft-stop phase of the second condition is terminated. In this case, the voltage converter 100 may perform an additional operation in response to the output voltage VOUT being equal to (or similar to) the first reference voltage VREF1. Additional operations performed by the voltage converter 100 are described in detail below with reference to FIGS. 15 and 16.

For example, in a condition where the magnitude of the load current ILOAD for discharging the output voltage VOUT is not sufficient, before the soft-stop phase is terminated, a condition where there is a time point at which the output voltage VOUT is discharged to the first reference voltage VREF1 may be classified as a third condition. For example, the third condition may correspond to a condition that the output voltage VOUT is discharged to the first reference voltage VREF1 before being discharged to the reset voltage VRST by the discharge current IDISCH in the soft-stop phase. That is, the third condition may correspond to a middle load condition.

Therefore, the soft-stop phase of the third condition may be understood as that in which the soft-stop phase of the second condition is specified. Alternatively, the soft-stop phase of the third condition may be understood to be a soft-stop stage of a condition different from the soft-stop stage of the first condition and the soft-stop stage of the second condition.

FIG. 15 illustrates a detailed operation method of a voltage converter according to embodiments of the present disclosure. For example, FIG. 15 illustrates an operation method in the soft-stop phase of the third condition of the voltage converter according to embodiments of the present disclosure. Referring to FIGS. 1, 2, 4A, 8, 10, 12, 14A, 14B, and 15, the voltage converter 100 according to embodiments of the present disclosure may discharge the output voltage VOUT to the first reference voltage VREF1 while performing the active discharge operation based on the discharge voltage VDISCH, as described above.

At operation S710, the voltage converter 100 may stop the switching operation in response to sensing that the magnitude of the inductor current IL is zero. Then, in operation S720, the voltage converter 100 may perform an active discharge operation. The operation of the voltage converter 100 according to operations S710 and S720 in FIG. 15 is the same as (or similar to) the operation of the voltage convertor 100 in the soft-stop phase of the second condition described above, and therefore, redundant detailed descriptions are omitted.

In operation S730, the voltage converter 100 may determine whether the output voltage VOUT is equal to the first reference voltage VREF1. For example, the control unit 140 of the voltage converter 100 may determine whether the output voltage VOUT is discharged to the first reference voltage VREF1 by the active discharge operation before the soft-stop operation is terminated. If the output voltage VOUT has been discharged to the first reference voltage VREF1 by the active discharge operation before the soft-stop operation is terminated, the voltage converter 100 may proceed to operation S740.

At operation S740, the voltage converter 100 may perform a switching operation in response to the output voltage VOUT being equal to the first reference voltage VREF1. For example, the plurality of switching elements of the converting unit 110 of the voltage converter 100 may perform the switching operation once in response to the output voltage VOUT being equal to the first reference voltage VREF1. For example, in response to the output voltage VOUT being equal to the first reference voltage VREF1, the control unit 140 may control the plurality of switching elements (e.g., the first switch TR1 and the second switch TR2) of the converting unit 110 of the voltage converter 100 to perform the switching operation once.

Specifically, according to the foregoing with respect to the operation of the voltage converter 100 in the soft-stop phase of the second condition, before the output voltage VOUT and the first reference voltage VREF1 are detected to be equal in operation S730, the zero-current signal ZCS is a signal of a logical high level, the plurality of switching elements of the converting unit 110 are all turned off, and the magnitude of the inductor current IL may be kept at zero.

In operation S740, as the plurality of switching elements of the converting unit 110 of the voltage converter 100 perform the switching operation, the output voltage VOUT increases for the on time period TON and then decreases again, and the magnitude of the inductor current IL may not be maintained at zero. Specifically, as the plurality of switching elements of the converting unit 110 perform switching operations, the magnitude of the inductor current IL may increase to a value greater than zero and then decrease back to zero. While the magnitude of the inductor current IL increases to a value greater than zero and then decreases back to zero, the zero-current signal may change to a logical low level.

If the magnitude of the inductor current IL decreases back to zero, the voltage converter 100 may return to operation S710 and repeat the above process. For example, the zero-current signal changed to the logical low level in operation S740 is changed to the logical high level in operation S710, the plurality of switching elements of the converting unit 110 are all turned off, and the magnitude of the inductor current IL may be maintained at zero.

In operation S750, the voltage converter 100 may determine whether the output voltage VOUT is equal to the reset voltage VRST. For example, the voltage converter 100 may determine whether the output voltage VOUT has been discharged to the reset voltage VRST. When the output voltage VOUT is not discharged to the reset voltage VRST, the voltage converter 100 may return to operation S730 and repeat the above-described process. When the output voltage VOUT is discharged to the reset voltage VRST, the voltage converter may terminate the soft-stop operation.

The operation of the voltage converter 100 in the soft-stop phase of the third condition is described in detail below with reference to FIGS. 15 and 16.

FIG. 16 illustrates an example of a third condition of a voltage converter according to embodiments of the present disclosure. Referring to FIG. 16, examples of the output voltage VOUT, the first reference voltage VREF1, the second reference voltage VREF2, the inductor current IL, the load current ILOAD, and the zero-current signal ZCS over time in the soft-stop phase of the third condition are illustrated.

The eleventh box B11 illustrates changes of the output voltage VOUT, the first reference voltage VREF1, and the second reference voltage VREF2 in the soft-stop phase of the third condition. The twelfth box B12 illustrates the change of the inductor current IL and the load current ILOAD in the soft-stop phase of the second condition. The thirteenth box B13 illustrates the change of the zero-current signal ZCS in the soft-stop phase of the second condition. In FIG. 16, the horizontal axis of the eleventh box B11 and the thirteenth box B13 indicates time T, and the vertical axis indicates voltage V. The horizontal axis of the twelfth box B12 indicates time T, and the vertical axis indicates current I.

The voltage converter 100 up to the sixth time point T6 in FIG. 16 is configured and may operate in the same manner as (or a similar manner to) the voltage converter 100 up to the fifth time point T5 in FIG. 14B. Therefore, redundant description is omitted. However, in the soft-stop phase of the third condition in FIG. 16, before the voltage converter 100 discharges the output voltage VOUT to the reset voltage VRST, the output voltage VOUT may be discharged to the first reference voltage VREF1.

At a seventh time point T7, the output voltage VOUT may be discharged to the first reference voltage VREF1 by the discharge current IDISCH. At the seventh time point T7, the voltage converter 100 may perform the switching operation once. For example, at the seventh time point T7, the control unit 140 of the voltage converter 100 may control the plurality of switching elements (e.g., the first switch TR1 and the second switch TR2) of the converting unit 110 to perform the switching operation once in response to the output voltage VOUT and the first reference voltage VREF1 being equal.

In the time period between the seventh time point T7 and the eighth time point T8, as the plurality of switching elements of the converting unit 110 perform the switching operation once, the magnitude of the inductor current IL may increase to a value greater than zero and then decrease back to zero in this case, which was maintained at zero from the sixth time point T6 to the seventh time point T7. Thus, in the time period between the seventh time point T7 and the eighth time point T8, the zero-current signal ZCS may be changed to a logical low level. Thus, in the time period between the seventh time point T7 and the eighth time point T8, the voltage converter 100 may not perform an active discharge operation.

In the time period between the seventh time point T7 and the eighth time point T8, when the first switch TR1 and the second switch TR2 of the converting unit 110 perform the switching operation, the on time period TON, which is the time period when the first switch TR1 is turned on and the second switch TR2 is turned off as described above, may correspond to the duty ratio of the switching operation of the voltage converter 100. For example, the on time period TON may be a time period of a determined value.

In the soft-stop phase, the offset voltage VOS may decrease to zero over a soft-stop time period. Thus, in the time period between the seventh time point T7 and the eighth time point T8, in the case of performing the switching operation based on the on time period TON, which is the time period of the transferred value, the case where the output voltage VOUT becomes equal to or larger than the second reference voltage VREF2 may occur. In this case, the amplifier AMP of the active discharge circuit 134 of the active discharging unit 130 may generate the discharge voltage VDISCH so as to increase the magnitude of the discharge current IDISCH.

At the eighth time point T8, the magnitude of the inductor current IL becomes zero, and the zero-current signal ZCS may change to a logical high level. At the eighth time point T8, the voltage converter 100 may again perform an active discharge operation.

At a ninth time point T9, the output voltage VOUT may be discharged to the first reference voltage VREF1 by the discharge current IDISCH. Accordingly, the voltage converter 100 may repeat the above-described operation as in the seventh time point T7.

Even in the soft-stop phase of the third condition in FIGS. 15 and 16, the voltage converter 100 may discharge the output voltage VOUT to the reset voltage VRST over the soft-stop time period by the above-described operation.

FIG. 17 is a block diagram illustrating an electronic system to which a voltage converter according to embodiments of the present disclosure is applied. Referring to FIG. 17, an electronic system 1000 may include a power management integrated circuit (PMIC) 1100 and a plurality of devices 1210-1240. In embodiments, the electronic system 1000 may be one of a variety of electronic devices, such as a mobile communication terminal, a Personal Digital Assistant (PDA), a Portable Media Player (PMP), a digital camera, a smartphone, a tablet computer, a laptop computer, a wearable device, or the like. Alternatively, the electronic system 1000 may be implemented as a System-on-chip (SoC), or System-on-Package (SoP).

The power management integrated circuit 1100 may receive the external power source PWR and generate a plurality of output voltages VOUT1, VOUT2, and VOUT3 based on the received external power source PWR. For example, the power management integrated circuit 1100 may include a first voltage regulator 1110 configured to generate a first output voltage VOUT1, a second voltage regulator 1120 configured to generate a second output voltage VOUT2, and/or a third voltage regulator 1130 configured to generate a third output voltage VOUT3.

In embodiments, each of the first through third voltage regulators 1110 to 1130 may be implemented by the voltage converter 100 described with reference to FIGS. 1 to 16 and/or may operate based on the operation method described with reference to FIGS. 1 to 16.

The plurality of devices 1210 to 1240 may include electronic circuitry, logic circuitry, or memory circuitry configured to support various operations of the electronic system 1000. The plurality of devices 1210 to 1240 may receive power from the power management integrated circuit 1100 and operate based on the provided power. For example, the first device 1210 may receive the first output voltage VOUT1 from the power management integrated circuit 1100, and operate based on the received first output VOUT1. The second device 1220 may receive the second output voltage VOUT2 from the power management integrated circuit 1100 and operate based on the received second output VOUT2. Each of the third device 1230 and the fourth device 1240 may receive the third output voltage VOUT3 from the power management integrated circuit 1100, and operate based on the received third output voltage Vout3.

In embodiments, the first to third output voltages VOUT1 to VOUT3 may have different values from each other, or may have the same value as (or similar values to) each other. For example, the first output voltage VOUT1 and the second output voltage VOUT2 may be the same (or similar), and the first output voltage VOUT1 and the third output voltage VOUT3 may be different, but this is an example, and the present disclosure is not limited thereto.

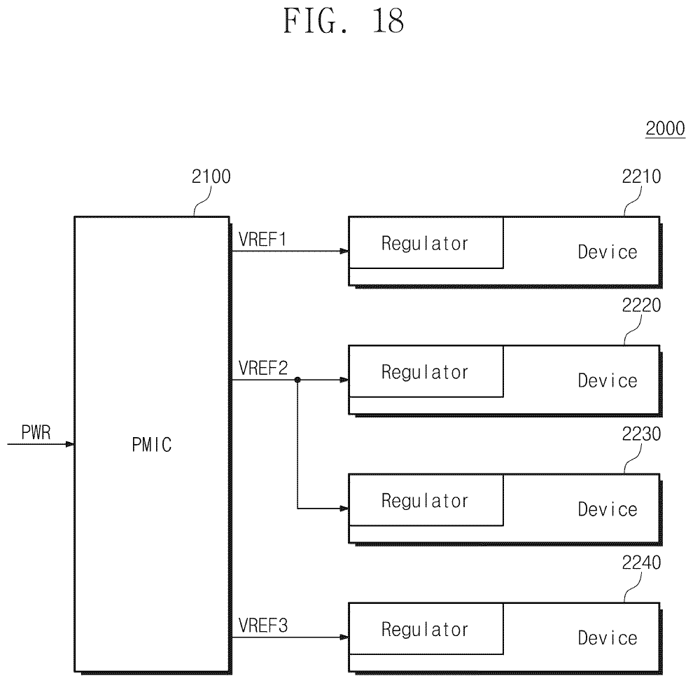

FIG. 18 is a block diagram illustrating an electronic system to which a voltage converter according to embodiments of the present disclosure is applied. Referring to FIG. 18, an electronic system 2000 may include a power management integrated circuit (PMIC) 2100, and a plurality of apparatuses 2110 to 2140.

The power management integrated circuit 2100 may generate a plurality of reference voltages VREF1 to VREF3 by using the external power source PWR. For example, the power supply management integrated circuit 2100 may generate a plurality of reference voltages VREF1 to VREF3 by using a reference voltage generator.

The plurality of apparatuses 2210 to 2240 may receive a plurality of reference voltages VREF1 to VREF3 from the power management integrated circuit 2100, and generate an operating voltage by using the received reference voltages VREF1 to VREF3. For example, each of the plurality of devices 2210 to 2240 may include a voltage regulator. The voltage regulator of the first device 2210 may generate, based on the first reference voltage VREF1, a first operating voltage used for the first device 2210. The voltage regulator of the second device 2220 may generate, based on the second reference voltage VREF2, a second operating voltage for use by the second device 2220. The voltage regulator of the third device 2230 may generate, based on the second reference voltage VREF2, a third operating voltage for use by the third device 2230. The voltage regulator of the fourth device 2240 may generate, based on the third reference voltage VREF3, a fourth operating voltage to be used by the fourth device 2240.

In embodiments, the voltage regulator included in each of the first through fourth devices 2210 to 2240 may be implemented by the voltage converter 100 described with reference to FIGS. 1 to 16.

In embodiments, the operating voltages generated using the same reference voltage (or similar reference voltages) may be the same as (or similar to) each other. For example, the second and third operating voltages generated in the voltage regulators of the second and third devices 2220 and 2230 using the second reference voltage may be the same as (or similar to) each other. Alternatively, operating voltages generated using the same reference voltage (or similar reference voltages) may have different levels. For example, the second and third operating voltages generated by the voltage regulators of the second and third devices 2220 and 2230 using the second reference voltage may be different from each other. This means that the implementation of the voltage regulator and the operating voltage required (or otherwise used) by each device may be varied in various ways depending on the level.

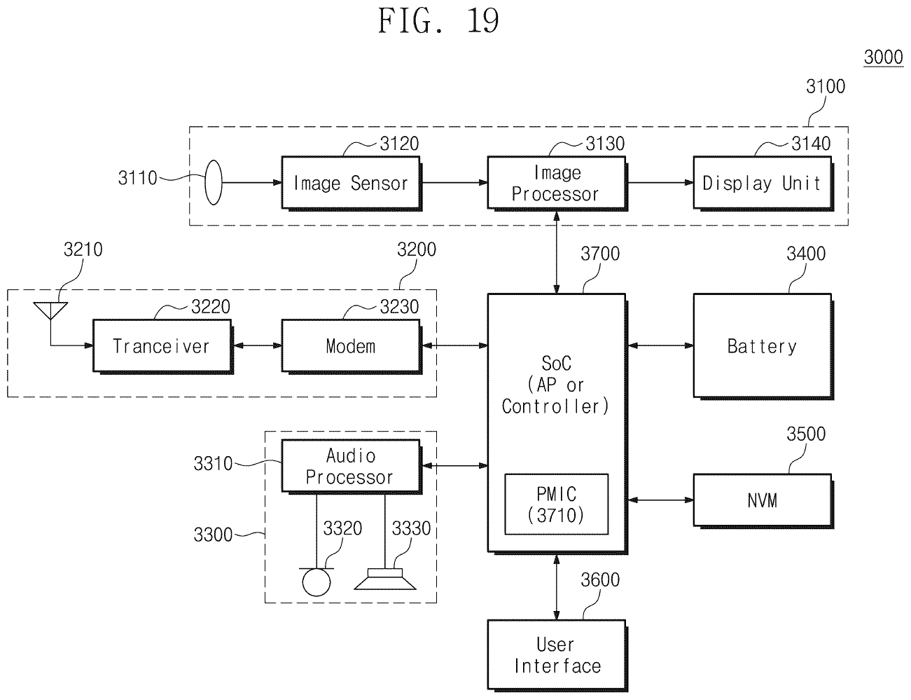

FIG. 19 is a block diagram illustrating an electronic device to which a voltage converter is applied, according to embodiments of the present disclosure. Referring to FIG. 19, an electronic device 3000 according to embodiments of the present disclosure may include an image processing unit 3100, a wireless transceiver unit 3200, an audio processing unit 3300, a battery 3400, a non-volatile memory device 3500, a user interface 3600, and/or a controller 3700 (may also be referred to herein as the SoC 3700). In embodiments, the electronic device 3000 may operate under control of the controller 3700.

The image processing unit 3100 includes a lens 3110, an image sensor 3120, an image processor 3130, and/or a display unit 3140. The image processor 3130 may convert a real image into image data through the lens 3110 and the image sensor 3120. The display unit 3140 may display an image data signal generated by the image processor 3130 or image data to be provided to the user. The display unit 3140 may be implemented with a liquid crystal display (LCD), an organic light emitting diode (OLED), etc. When the LCD or the OLED is implemented in a touch screen manner, the display unit 3140 may operate together with the user interface 3600.

The wireless transceiver unit 3200 includes an antenna 3210, a transceiver 3220, and/or a modulator/demodulator (modem) 3230. The wireless transceiver unit 3200 may perform a wireless communication function. The transceiver 3220 may adjust a frequency of a signal to be transmitted through the antenna 3210 or may amplify the signal and may adjust a frequency of a signal received through the antenna 3210 or may amplify the signal. The modem 3230 may include a transmitter encoding and modulating a signal to be transmitted and a receiver demodulating and decoding a signal received through the antenna 3210. The antenna 3210 and the modem 3230 of the wireless transceiver unit 3200 may process signals exchanged with an external device/system, based on at least one of various wireless communication protocols: long term evolution (LTE), worldwide interoperability for microwave access (WiMax), global system for mobile communication (GSM), code division multiple access (CDMA), Bluetooth, near field communication (NFC), wireless fidelity (Wi-Fi), radio frequency identification (RFID), etc.

The audio processing unit 3300 includes an audio processor 3310, a microphone 3320, and/or a speaker 3330. The audio processing unit 3300 may constitute a codec, and the codec may include a data codec and/or an audio codec. The data codec may process packet data or the like, and the audio codec may process a voice and an audio signal such as a multimedia file. Also, the audio processing unit 3300 may perform a function of converting and/or replaying a digital audio signal received by the modem 3230 into an audio analog signal through the audio codec, or converting an analog audio signal generated from the microphone 3320 into a digital audio signal so as to be transmitted to the modem 3230. The codec may be provided separately or may be included in the SoC 3700.

The battery 3400 may provide power necessary (or otherwise, used) for the operation of the electronic device 3000. In FIG. 19, the electronic device 3000 is illustrated as receiving the power from the battery 3400, but it should be understood that embodiments in which an external power source performs a role of the battery 3400 also belong to the scope of the present disclosure. The non-volatile memory device 3500 may store data of the electronic device 3000. For example, the non-volatile memory device 3500 may be a NAND flash memory device or may include the NAND flash memory device. The non-volatile memory device 3500 may be provided as a memory card (e.g., MMC, eMMC, SD, micro SD, etc.) according to embodiments of the present disclosure.

The user interface 3600 may receive an input from the outside or may generate an output to the outside. For example, the user interface 3600 may receive an input through an input device such as a keyboard or a mouse. In embodiments, the user interface 3600 may include a driver for receiving the input from the input devices. In embodiments, the user interface 3600 may generate an output while operating with the display unit 3140 or the audio processing unit 3300 together.

The SoC 3700 may drive an application program or an operating system. In embodiments, the controller 3700 may include a processor such as a general purpose processor or a specific purpose processor. In embodiments, the controller 3700 may control the components of the electronic device 3000. The controller 3700 may include an PMIC 3710. The PMIC 3710 may be supplied with a voltage from the battery 3400 and may convert the level of the supplied voltage. The PMIC 3710 may provide the converted voltage level to the respective components of the electronic device 3000. According to embodiments, PMIC 3710 may be implemented by the voltage converter 100 described with reference to FIGS. 1 to 16.

The components of the electronic device 3000 illustrated in FIG. 19 are provided as an example, and the scope of the present disclosure is not limited thereto. For example, the electronic device 3000 may further include a volatile memory device as a system memory, and the volatile memory device may operate under control of the controller 3700. In embodiments, the electronic device 3000 may not include some of the components of FIG. 19. For example, the electronic device 3000 may not include the image processing unit 3100.

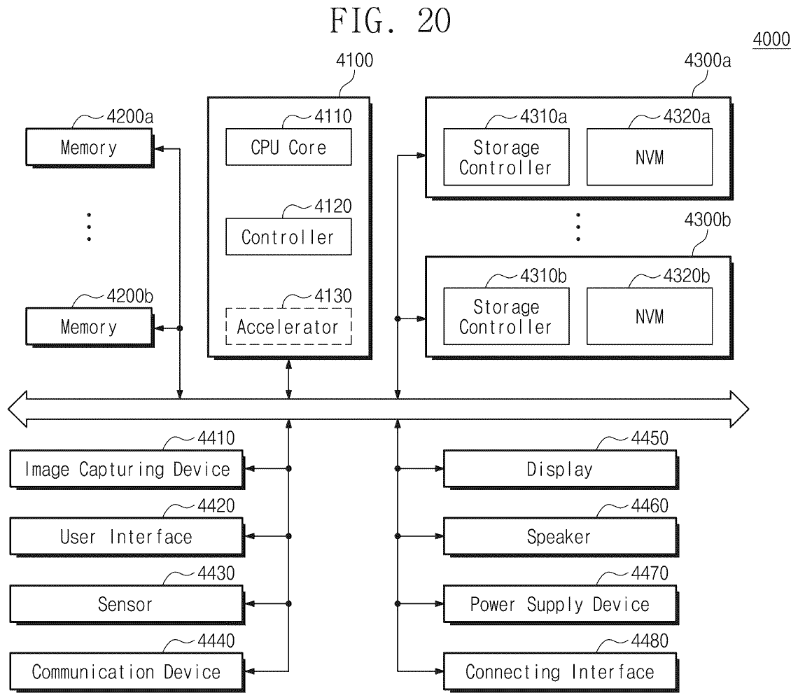

FIG. 20 is a diagram illustrating a system to which a voltage converter according to embodiments of the present disclosure is applied. The system 4000 of FIG. 20 may basically be a mobile system, such as a portable communication terminal (e.g., a mobile phone), a smartphone, a tablet personal computer (PC), a wearable device, a healthcare device, an Internet of things (IOT) device, etc. However, the system 4000 of FIG. 20 is not necessarily limited to the mobile system and may be a PC, a laptop computer, a server, a media player, an automotive device (e.g., a navigation device), etc.

Referring to FIG. 20, the system 4000 may include a main processor 4100, memories (e.g., 4200a to 4200b), and/or storage devices (e.g., 4300a to 4300b). In addition, the system 4000 may include at least one of an image capturing device 4410, a user input device 4420 (may also be referred to herein as a user interface), a sensor 4430, a communication device 4440, a display 4450, a speaker 4460, a power supplying device 4470 (may also be referred to herein as a power supply device), and/or a connecting interface 4480.

The main processor 4100 may control all operations of the system 4000, more specifically, operations of other components included in the system 4000. The main processor 4100 may be implemented as a general-purpose processor, a dedicated processor, or an application processor.

The main processor 4100 may include at least one CPU core 4110 and further include a controller 4120 configured to control the memories 4200a to 4200b and/or the storage devices 4300a to 4300b. In embodiments, the main processor 4100 may further include an accelerator 4130, which is a dedicated circuit for a high-speed data operation, such as an artificial intelligence (AI) data operation. The accelerator 4130 may include a graphics processing unit (GPU), a neural processing unit (NPU) and/or a data processing unit (DPU) and be implemented as a chip that is physically separate from the other components of the main processor 4100.

The memories 4200a to 4200b may be used as main memory devices of the system 4000. Although each of the memories 4200a to 4200b may include a volatile memory, such as static random access memory (SRAM) and/or dynamic RAM (DRAM), each of the memories 4200a to 4200b may include non-volatile memory, such as a flash memory, phase-change RAM (PRAM) and/or resistive RAM (RRAM). The memories 4200a to 4200b may be implemented in the same package as (or a similar package to) the main processor 4100.

The storage devices 4300a to 4300b may serve as non-volatile storage devices configured to store data regardless of whether power is supplied thereto, and have larger storage capacity than the memories 4200a to 4200b. The storage devices 4300a to 4300b may respectively include storage controllers (STRG CTRL) 4310a to 4310b and NVMs (Non-Volatile Memories) 4320a to 4320b configured to store data via the control of the storage controllers 4310a to 4310b. Although the NVMs 4320a to 4320b may include flash memories having a two-dimensional (2D) structure or a three-dimensional (3D) V-NAND structure, the NVMs 4320a to 4320b may include other types of NVMs, such as PRAM and/or RRAM.

The storage devices 4300a to 4300b may be physically separate from the main processor 4100 and included in the system 4000, or implemented in the same package as (or a similar package to) that of the main processor 4100. In addition, the storage devices 4300a to 4300b may have types of solid-state devices (SSDs) or memory cards and be removably combined with other components of the system 400 through an interface, such as the connecting interface 4480 that will be described below. The storage devices 4300a to 4300b may be devices to which a standard protocol, such as a universal flash storage (UFS), an embedded multi-media card (eMMC), a non-volatile memory express (NVMe), etc., is applied, without being limited thereto.

The image capturing device 4410 may capture still images or moving images. The image capturing device 4410 may include a camera, a camcorder, and/or a webcam.

The user input device 4420 may receive various types of data input by a user of the system 4000 and include a touch pad, a keypad, a keyboard, a mouse, and/or a microphone.

The sensor 4430 may detect various types of physical quantities, which may be obtained from the outside of the system 4000, and convert the detected physical quantities into electric signals. The sensor 4430 may include a temperature sensor, a pressure sensor, an illuminance sensor, a position sensor, an acceleration sensor, a biosensor, and/or a gyroscope sensor.

The communication device 4440 may transmit and receive signals between other devices outside the system 4000 according to various communication protocols. The communication device 4440 may include an antenna, a transceiver, and/or a modem.

The display 4450 and the speaker 4460 may serve as output devices configured to respectively output visual information and auditory information to the user of the system 4000.

The power supplying device 4470 may appropriately convert power supplied from a battery (not shown) embedded in the system 4000 and/or an external power source, and supply the converted power to each of components of the system 4000. According to embodiments, power supplying device 4470 may be implemented by the voltage converter 100 described with reference to FIGS. 1 to 16.

The connecting interface 4480 may provide connection between the system 4000 and an external device, which is connected to the system 4000 and capable of transmitting and receiving data to and from the system 4000. The connecting interface 4480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and/or a compact flash (CF) card interface.

According to embodiments of the present disclosure, when the voltage converter performs the soft-stop operation, the current source may discharge the output voltage. Therefore, when performing a soft-stop operation, the voltage converter including improved performance without overshoot occurring at the input voltage and an operation method of the voltage converter are provided.

Voltage converters may perform a soft-stop operation based on termination of a voltage conversion operation of the voltage converters. In scenarios in which a magnitude of a load current is insufficient or zero (e.g., the second condition), an output voltage may be not discharged by the load current in the soft-stop operation. Conventional devices and methods attempt to address this challenge by turning off a low-side switch until a magnitude of an inductor current falls below zero, thereby discharging the output voltage. However, this reversal of the inductor current flow may result in the inductor current flowing to an input terminal of the voltage converter based on a high-side switch being turned on, thereby causing damage to the voltage converter and/or peripheral devices. Also, the conventional devices and methods are unable to control an amount of time taken to perform the soft-stop operation consistently or accurately based on the negative inductor current caused by turning off the low-side switch.

However, according to embodiments, improved devices and methods are provided for a voltage converter soft-stop operation. For example, the improved devices and methods may involve performing an active discharge operation in response to determining a magnitude of an inductor current has fallen to zero, thereby enabling consistent and accurate control of an amount of time taken to perform the soft-stop operation. Also, contemporaneous with the active discharge operation, high-side and low-side switches may be turned off, thereby preventing the inductor current from flowing towards an input terminal (or reducing the amount of inductor current flowing towards the input terminal) of the voltage converter. Accordingly, the improved devices and methods overcome the deficiencies of the conventional devices and methods to at least prevent and/or reduce damage to the voltage converter and/or peripheral devices, and/or control a soft-stop operation duration with greater accuracy and consistency.

According to embodiments, operations described herein as being performed by the voltage converter 100, the reference generating unit 120, the active discharging unit 130, the control unit 140, the reference generator 122, the offset adder 124, the zero-current detector 132, the active discharge circuit 134, the ripple injection block 142, the control logic block 144, the driver block 146, the amplifier AMP, the electronic system 1000, the PMIC 1100, each of a plurality of devices 1210-1240, the first voltage regulator 1110, the second voltage regulator 1120, the third voltage regulator 1130, the electronic system 2000, the PMIC 2100, each of the plurality of apparatuses 2110 to 2140, the electronic device 3000, the image processing unit 3100, the wireless transceiver unit 3200, the audio processing unit 3300, the controller 3700, the image sensor 3120, the image processor 3130, the transceiver 3220, the modulator/demodulator (modem) 3230, the audio processor 3310, the PMIC 3710, the system 4000, the main processor 4100, the image capturing device 4410, the communication device 4440, the power supplying device 4470, the connecting interface 4480, the at least one CPU core 4110, the controller 4120, accelerator 4130, and/or each of the storage controllers (STRG CTRL) 4310a to 4310b may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Any of the arrows or lines that interconnect the components in the drawings may represent physical data paths, logical data paths, or both. A physical data path may comprise a data bus or a transmission line, for example. A logical data path may represent a communication or data message between software programs, software modules, subroutines, or other software constituents or components.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A voltage converter comprising:
a first circuit including a first switch, a second switch, an inductor and a current source, the first circuit being configured to convert an input voltage into an output voltage based on a switching operation of the first switch and the second switch; and
processing circuitry configured to,
generate a first reference voltage and a second reference voltage,
control the switching operation of the first switch and the second switch based on an inductor current flowing in the inductor, the output voltage and the first reference voltage,
reduce the first reference voltage and the second reference voltage to a reset voltage during a soft-stop time period of a soft-stop phase, and
control a discharge current flowing in the current source in the soft-stop phase based on a magnitude of the inductor current, the output voltage and the second reference voltage.

2. The voltage converter of claim 1, wherein the first circuit further includes:
a bulk capacitor configured to store a bulk voltage, the bulk voltage being corresponding to the input voltage from which a noise is removed, and the bulk capacitor being connected between a first node and a ground node; and
an output capacitor configured to store the output voltage, the output capacitor being connected between an output node and the ground node,
wherein
the first switch is connected between the first node and a second node,
the second switch is connected between the second node and the ground node,
the inductor is connected between the second node and the output node, and
the current source is connected between the output node and the ground node.

3. The voltage converter of claim 2, wherein
the processing circuitry is configured to cause the first switch and the second switch to perform the switching operation such that the output voltage is equal to or greater than the first reference voltage; and
the first circuit is configured to perform the switching operation such that the inductor current does not flow from the second node to the first node in the soft-stop phase.

4. The voltage converter of claim 3, wherein
the processing circuitry is configured to cause the switching operation to be performed in response to detecting that the output voltage is equal to the first reference voltage; and
the switching operation includes,
turning on the first switch for an on time period, the second switch being turned off for the on time period,
turning off the first switch based on termination of the on time period, and
turning on the second switch based on termination of the on time period.

5. The voltage converter of claim 4, wherein
the output voltage is reduced to the reset voltage during the soft-stop time period; and
the output voltage becomes equal to the reset voltage corresponding to termination of the soft-stop phase.

6. The voltage converter of claim 5, wherein the processing circuitry is configured to:
cause the first switch and the second switch to perform the switching operation in the soft-stop phase based on the magnitude of the inductor current not being zero; and
perform first operations based on the magnitude of the inductor current being zero, the first operations including,
causing the first switch and the second switch to turn off, and
cause the current source to generate the discharge current, the output voltage being discharged to the reset voltage based on the discharge current.

7. The voltage converter of claim 6, wherein
the current source is a discharge transistor controlled by a discharge voltage; and
the discharge transistor is configured to cause the discharge current to flow according to the discharge voltage.

8. The voltage converter of claim 1, wherein the processing circuitry is configured to generate the second reference voltage by adding an offset voltage to the first reference voltage.

9. The voltage converter of claim 8, wherein the processing circuitry is configured to reduce the offset voltage to zero during the soft-stop time period.

10. The voltage converter of claim 1, further comprising:
an active discharge circuit,
wherein
the processing circuitry is configured to,
detect the magnitude of the inductor current, and
generate a zero-current signal based on the magnitude of the detected inductor current and
the active discharge circuit is configured to generate a discharge voltage based on the output voltage, the second reference voltage and the zero-current signal, the current source being controlled based on the discharge voltage.

11. The voltage converter of claim 10, wherein the processing circuitry is configured to:
generate the zero-current signal at a logical low level in the soft-stop phase based on the magnitude of the inductor current not being zero; and
generate the zero-current signal at a logical high level in the soft-stop phase based on the magnitude of the inductor current being zero.

12. The voltage converter of claim 11, wherein
the active discharge circuit is implemented based on an amplifier including a non-inverting terminal, an inverting terminal, an enable terminal and an output terminal;
the enable terminal is configured to enable the amplifier in response to the zero-current signal at the logical high level; and
the amplifier is configured to output the discharge voltage to the output terminal based on the output voltage received to the non-inverting terminal and the second reference voltage received to the inverting terminal.

13. The voltage converter of claim 1, wherein the processing circuitry is configured to:
generate a ripple injected voltage by injecting a ripple voltage into the output voltage;
generate a driver control signal based on the ripple injected voltage, the inductor current and the first reference voltage; and
generate a first drive signal and a second drive signal based on the driver control signal, the first switch being controlled based on the first drive signal, and the second switch being controlled based on the second drive signal.

14. The voltage converter of claim 13, wherein the processing circuitry is configured to:
control the switching operation of the first switch and the second switch based on the first drive signal and the second drive signal in the soft-stop phase based on the magnitude of the inductor current not being zero; and
turn off both of the first switch and the second switch based on the first drive signal and the second drive signal in the soft-stop phase based on the magnitude of the inductor current being zero.

15. A soft-stop operation method of a voltage converter, comprising:
reducing, by processing circuitry, a first reference voltage and a second reference voltage to a reset voltage during a soft-stop time period, an offset voltage being added to the first reference voltage to obtain the second reference voltage;
detecting, by the processing circuitry, a magnitude of an inductor current flowing in an inductor included in a first circuit, an output voltage of the first circuit being equal to or greater than the first reference voltage;
stopping, by the processing circuitry, a switching operation in response to the magnitude of the inductor current being zero, the stopping being performed by controlling a first switch and a second switch included in the first circuit;
causing, by the processing circuitry, a discharge voltage to be provided to a current source in response to the magnitude of the inductor current being zero, the current source being included in the first circuit;
generating, by the current source, a discharge current in response to the discharge voltage; and
discharging, by the current source, the output voltage to the reset voltage based on the discharge current.

16. The soft-stop operation method of the voltage converter of claim 15, wherein the causing the discharge voltage to be provided to the current source includes:
generating, by the processing circuitry, a zero-current signal at a logical high level in response to the magnitude of the inductor current being zero; and
generating, by an active discharge circuit, the discharge voltage based on the output voltage and the second reference voltage in response to the zero-current signal at the logical high level.

17. The soft-stop operation method of the voltage converter of claim 15, wherein the stopping the switching operation includes:
generating, by the processing circuitry, a driver control signal for the first switch and the second switch to stop the switching operation in response to the magnitude of the inductor current being zero; and
causing, by the processing circuitry, both of the first switch and the second switch to turn off based on a first drive signal and a second drive signal in response to the driver control signal.

18. A voltage converter comprising:
a first circuit including a current source for discharging an output voltage; and
processing circuitry configured to,
cause a discharge voltage to be generated based on an inductor current flowing in an inductor, the inductor being included in the first circuit, and
perform a soft-stop operation including causing the discharge voltage to be provided to the current source based on a magnitude of the inductor current being zero, the current source being configured to generate a discharge current in response to the discharge voltage, and the discharge current causing the output voltage to discharge to a reset voltage.

19. The voltage converter of claim 18, wherein
the first circuit includes a first switch and a second switch that convert an input voltage into the output voltage by a switching operation; and
the processing circuitry is configured to perform the soft-stop operation including causing the first switch and the second switch to stop the switching operation.

20. The voltage converter of claim 18, wherein the processing circuitry is configured to:
generate a first reference voltage and a second reference voltage, the output voltage being equal to or greater than the first reference voltage; and
perform the soft-stop operation including causing the discharge voltage to be generated based on the output voltage and the second reference voltage in response to the magnitude of the inductor current being zero.
